(19) United States
(12) Patent Application Publication
(10) Pub. No.: US 2015/0208410 A1
(43) Pub. Date: Jul. 23, 2015

(54) Nodes and Methods Therein for Managing Time-Frequency Resources

(71) Applicant: Telefonaktiebolaget L M Ericsson (publ), Stockholm (SE)

(72) Inventors: Chrysostomos Koutsimanis, Solna (SE); Angelo Centonza, Winchester (GB); Muhammad Kazmi, Bromma (SE)

(21) Appl. No.: 14/416,311

(22) PCT Filed: Jul. 15, 2013
(86) PCT No.: PCT/SE2013/050905

§ 371 Date: Jan. 22, 2015

Related U.S. Application Data
(60) Provisional application No. 61/677,174, filed on Jul. 30, 2012.

(51) Int. Cl. H04W 72/04; H04W 72/08; H04L 5/00; H04W 24/10

(52) U.S. Cl. CPC H04W 72/0453; H04W 24/10; H04W 72/085; H04L 5/0005

(57) ABSTRACT

Method in a first node for managing time-frequency resources. The first node is comprised in a wireless network. The first node serves at least one user equipment in the wireless network. The first node determines a blanking ratio of a low interference time-frequency resource pattern, and/or an amount of required protected time-frequency resources. The determining is based on one or more parameters related to the user equipment served by the first node. The determining is for recommending to a second node comprised in the wireless network, and using the low interference time-frequency resource pattern. The first node signals information to the second node. The information comprises at least one of: the determined blanking ratio, the determined required amount of protected time-frequency resources, and the one or more parameters. The at least one user equipment served by the first node receives interference from the second node.

### TECHNICAL FIELD

This disclosure relates to a method for coordinating interference among network nodes in a Heterogeneous wireless network. More specifically, this disclosure relates to a method and signaling means to ensure that aggressor network nodes optimize capacity while providing an adequate number of protected time-frequency resources to corresponding resources in victim nodes.

### BACKGROUND

Communication devices such as terminals are also known as e.g. User Equipments (UE), mobile terminals, wireless terminals and/or mobile stations. Terminals are enabled to communicate wirelessly in a cellular communications network or wireless communication system, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

Terminals may further be referred to as mobile telephones, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE controlled by the radio base station.

Heterogeneous networks are currently a hot topic in the 3GPP standardization body as well as in discussion forums with operators. Deploying small base stations to enhance capacity or coverage seems to be an appealing way for operators to overcome the burden of finding and leasing new macro sites. Those deploying these small base stations must consider, however, the extent to which they can offload the macro cells and how extensive their coverage can be. One way to increase the coverage area of a small node is to apply a Cell Selection Offset (CSO) to the cell selection algorithm and thus steer more users, e.g., User Equipments (UEs), to the small nodes layer.

A potential problem with the above solution is that users in the Cell Range Extended (CRE) areas of, for example, pico cells are usually heavily interfered with by the macro cell in the downlink. Thus, users in that area may not be able to correctly decode the control channel, e.g., Physical Hybrid automatic repeat request Indicator CHannel (PHICH), Physical Downlink Control CHannel (PDCCH), etc. . . . , or perform other Radio Resource Management (RRM) operations such as cell identification, RRM measurements, Radio Link Monitoring (RLM), etc. . . . . One way to mitigate such problems is to apply resource restrictions in the macro layer. Using the Almost Blank Subframes (ABS) Enhanced Inter-Cell Interference Coordination (eICIC) feature in Long-Term Evolution (LTE) Release 10 (Rel-10), macro cells do not schedule users on specific subframes, thereby reducing interference to pico users in the CRE area. This method can protect both the data and control channels of CRE users.

Time Domain eICIC

In Rel-10, time domain eICIC is specified. In a time domain scheme, there is resource partitioning in the time domain between the aggressor cell and the victim cell to mitigate interference in the victim cells. This mechanism is being further enhanced in Release-11.

According to the time domain eICIC scheme, the subframe utilization across different cells is coordinated in time through backhaul signaling, i.e., over X2 between nodes such as eNodeBs (eNBs). The subframe utilization is expressed in terms of a time domain pattern of low interference subframes or a low interference transmit pattern.’ More specifically, they are called Almost Blank Subframe (ABS) patterns. The Almost Blank Subframes (ABSs) are configured in an aggressor cell, e.g., a macro cell, and are used to protect resources in subframes in the victim cell, e.g., a pico cell, receiving strong inter-cell interference.

ABSs are subframes configured in an aggressor cell with reduced or no transmission power and/or reduced activity on some of the physical channels. In an ABS subframe, the basic common physical channels such as Cell-specific Reference Signal (CRS), Primary Synchronization Signal/Secondary Synchronization Signal (PSS/SSS), Physical Broadcast CHannel (PBCH) and System Information Block 1 (SIB1) are transmitted to ensure the operation of the legacy User Equipment (UE). Therefore, ABS can be categorized as Zero Power ABS (ZP-ABS), Reduced Power ABS (RP-ABS), Reduced Activity ABS (RA-ABS), or a combination of RP-ABS and RA-ABS. In this disclosure, the terms interference protected resources, protected resources, and protected subframes are equivalently used to specify frequency resources within ABSs or within subframes allocated to protect victim cells from interference.

The ABS pattern can also be categorized as Multicast-Broadcast Single Frequency Networks (MBSFN) and non-MBSFN. In non-MBSFN ABS patterns, an ABS can be configured in any subframe, i.e., MBSFN or non-MBSFN configurable subframes. In MBSFN ABS patterns, an ABS can only be configured in MBSFN configurable subframes, i.e., subframes 1, 2, 3, 6, 7 and 8 in Frequency Division Duplex (FDD) and subframes 3, 4, 7, 8, and 9 in Time-Division Duplex (TDD).

The serving eNB uses one or more measurement patterns, i.e. measurement resource restriction pattern, to inform the UE about the resources or subframes which the UE should use for performing measurements on a target victim cell, e.g., a serving pico cell and/or neighboring pico cells. The resources or subframes on which the measurements are to be done by the UE overlap with ABS subframes in aggressor cell(s). Therefore these resources or subframes within a measurement pattern are protected from aggressor cell interference. Accordingly, these are called protected subframes or resources.

These measurement patterns are communicated to the UE via Radio Resource Control (RRC) signaling in the RRC_CONNECTED state. In later releases the pattern may also be configured in the RRC_IDLE state. A measurement pattern is typically a subset of an ABS pattern configured in an aggressor cell. There are different patterns depending on the type of measured cell, i.e., serving or neighbor cell, and measurement type, e.g., RRM, RLM, Channel State Information (CSI) etc. . . . . More specifically, in Rel-10 there are three kinds of measurement resource restriction patterns that may be configured for the UE to measure on a victim cell. More patterns may be introduced in future releases.
Pattern 1: A single RRM/RLM measurement resource restriction for the Primary cell (PCell).
Pattern 2: A single RRM measurement resource restriction for all, or indicated list of, neighbor cells operating in the same carrier frequency as the PCell.
Pattern 3: Resource restriction for CSI measurement of the PCell. If configured, two subframe subsets are configured per UE. The UE reports CSI for each configured subframe subset.

More specifically for eICIC in Rel-10, a parameter called “measSubframeCellList” is sent to the UE via RRC as defined in TS 36.331. It contains a list of cells for which “measSubframePatternNeigh” is applied. The parameter “measSubframePatternNeigh” is the ‘time domain measurement resource restriction pattern’ applicable for doing Reference Signal Received Power (RSRP) and Reference Signal Received Quality (RSRQ) measurements in a neighbor cell on the indicated carrier frequency.

### Signaling of ABS and MBSFN Information Over X2

In current X2AP protocol specifications captured in TS36.423, two mechanisms are defined to exchange information on ABS pattern allocation and utilization.

The first mechanism is the X2: LOAD INFORMATION procedure by means of which a victim, e.g., pico, eNB may request the allocation of ABS patterns by the aggressor, e.g., macro, eNB. This is facilitated by including in the X2: LOAD INFORMATION message the “Invoke Indication” Information Element (IE), as shown in FIG. 1, step 1. As a result of the ABS invoke message, the aggressor, e.g., macro, eNB may decide to allocate ABS patterns and to signal such patterns to the victim, e.g., pico, eNB by including the “ABS Information” IE in a new X2: LOAD INFORMATION message to the victim eNB, see step 2 of FIG. 1.

Once the process of ABS pattern allocation is completed, current specifications allow the aggressor eNB to monitor the utilization of ABS subframes by requesting the ABS Status report. This report is requested in the X2: RESOURCE STATUS REQUEST, where the fifth bit, Fifth Bit=ABS Status Periodic, of the Report Characteristic IE is set to 1. In response, the victim eNB sends an X2: RESOURCE STATUS RESPONSE message, where the successful establishment of periodic reporting is confirmed, see step 3 of FIG. 1.

After configuration of the resource status reporting, the victim eNB sends periodic X2: RESOURCE STATUS UPDATE messages to the aggressor eNB, including the “ABS Status” IE. This IE provides information about the subframes included in the ABS pattern allocated by the aggressor eNB that are used by the victim eNB to schedule UEs in adverse interference conditions. Information about ABS utilization is included in the “Usable ABS Pattern Info” IE contained in the “ABS Status” IE. The “Usable ABS Pattern Info” IE semantics are defined in TS36.423 as follows:
“Each position in the bitmap represents a subframe, for which value “1” indicates ‘ABS that has been designated as protected from inter-cell interference by the eNB1, and available to serve this purpose for DL scheduling in the eNB2’ and value “0” is used for all other subframes.
The pattern represented by the bitmap is a subset of, or the same as, the corresponding ABS Pattern Info IE conveyed in the LOAD INFORMATION message from the eNB1.”

It should be noted that the current “Usable ABS Pattern Info” IE only allows a report of the ABS subframes usable by the victim eNB as a subset of the ABS pattern assigned by the aggressor eNB requesting the X2: RESOURCE STATUS UPDATE procedure.

### UE Signal Measurements

In order to support different mobility functions, e.g., cell selection, cell reselection, handover, RRC re-establishment, connection release with redirection, minimization of drive tests, Self-Organizing Network (SON) positioning, scheduling, link adaptation, etc. . . . , the UE is required to perform one or more measurements on the signals transmitted by the serving cell and the neighboring cells.

The measurements are typically performed over a relatively long time duration, i.e., 100 milliseconds (ms) to a few seconds. The same measurements are applicable to both single carrier and Carrier Aggregation (CA) systems. However, in CA systems the measurement requirements may be different, e.g., it can be either relaxed or more stringent depending upon whether the Secondary Component Carrier (SCC) is activated. It may also depend upon the UE capability, i.e., whether a CA capable UE is able to perform the measurement on SCC with or without gaps.

Examples of mobility measurements in LTE are:
Reference Symbol Received Power (RSRP)
Reference Symbol Received Quality (RSRQ)

The mobility measurements may also comprise identifying or detecting a target cell, which may belong to one of several different networks, e.g., LTE, High-Speed Packet Access (HSPA), Code Division Multiple Access 2000 (CDMA2000), Global System for Mobile communications (GSM), etc. . . . . Indeed, before taking a radio measurement, the UE must identify a cell and determine its Physical Cell Identity (PCI). Therefore, PCI determination, a.k.a. cell identification, is also a type of measurement. Later, the UE measures the signal strength, e.g., RSRP, and/or signal quality, e.g., RSRQ, of the serving cell and one or more neighbor cells.

In LTE, the serving cell can ask the UE to acquire the System Information (SI) of the target cell. More specifically, the UE reads the SI to acquire the Cell Global Identifier (CGI) of the target cell which uniquely identifies the cell. The UE reads the SI of the target cell, e.g., intra-frequency, inter-frequency or inter-Radio Access Technology (RAT) cell upon receiving an explicit request from the serving network node via RRC signaling, e.g., from a Radio Network Controller (RNC) in High-Speed Packet Access (HSPA) or eNode B in LTE). The acquired SI is then reported to the serving cell. To acquire the SI containing the CGI of the target cell, the UE has to read at least part of the SI, including the Master Information Block (MIB) and the relevant System Information Block (SIB), e.g., SIB1. The terms SI reading/decoding/acquisition, CGI/E-UTRAN Cell Global Identifier (ECGI) reading/decoding/acquisition, and CSG SI reading/decoding/acquisition are interchangeably used but have the same or similar meaning and is also considered to be a type of UE measurement.

Other examples of measurements are Radio Link Monitoring (RLM) of the serving cell which further comprises Out Of Sync (OOS) and in sync detection. The RLM measurement enables the UE to monitor the radio link quality of the serving cell and the UE takes an appropriate action based on that information, e.g., declares radio link failure if a network configurable timer, e.g., T310, which starts after N consecutive out of sync detections expires.

Examples of positioning measurements in LTE are:
Reference Signal Time Difference (RSTD)
UE Receive-Transmit (RX-TX) time difference measurement

The UE RX-TX time difference measurement requires the UE to measure the downlink reference signal, e.g., CRS, as well as the uplink transmitted signals, e.g., Sounding Reference Signals (SRSs).

RSTD is performed by measuring the Positioning Reference Signal (PRS) and is used for Observed Time Difference of Arrival (OTDOA) positioning.

Examples of other measurements which may be used for Minimization of Drive Tests (MDT), SON or for other purposes are:
Control channel failure rate or quality estimate, e.g.:
   Paging channel failure rate
   Broadcast channel failure rate
Physical layer problem detection, e.g.:
   Out of synchronization (out of sync) detection
   In synchronization (in-sync) detection
   Radio link monitoring

This disclosure applies, but is not limited to, all of the measurement types indicated above.

In its connected state, the UE reports the neighbor cell measurements to the serving node. In response to the reported UE measurements, the serving network node makes a decision, such as commanding the UE to change cells. Examples of cell change include handover, RRC connection re-establishment, RRC connection release with redirection, PCell change in CA, Primary Component Carrier (PCC) change in PCC, etc. In an idle or low activity state, an example of cell change is cell reselection.

To assist in scheduling and link adaptation, the UE performs measurements which are broadly classified as “Channel State Information” (CSI). CSI is performed on the serving cell, or all serving cells in the case of CA. Examples of CSI measurements include Channel Quality Indicator (CQI), Precoding Matrix Index (PMI), and Rank Indicator (RI). CSI measurements are taken over a relatively shorter period, e.g., 2-5 ms, compared to the mobility related measurements. The serving cell uses the UE reported CSI measurements for several purposes, such as scheduling, link adaptation and short term radio link assessment.

### Multi-Carrier or Carrier Aggregation Concept

Multi-carrier, or carrier aggregation solutions are known to enhance the peak-rates within a technology. Each carrier in a Carrier aggregation (CA) system is generally referred to as a Component Carrier (CC) or a cell. Simply put, the CC is an individual carrier in a multi-carrier system. CA, “multi-carrier system”, “multi-cell operation”, “multi-carrier operation”, “multi-carrier” transmission and/or reception may all be used interchangeably. CA is used for transmission of signaling and data in the uplink and downlink directions. One of the CCs is the Primary Component Carrier (PCC), i.e., the primary carrier or anchor carrier. The remaining CCs are called Secondary Component Carriers (SCC), i.e., secondary carriers or supplementary carriers. Generally, the primary or anchor CC carries the essential UE specific signaling. The PCC exists in both the uplink and downlink CA. The network may assign different primary carriers to different UEs operating in the same sector or cell.

Thus, the UE can have more than one serving cell in the downlink and/or in the uplink: one primary serving cell and one or more secondary serving cells operating the PCC and SCC, respectively. The primary serving cell is interchangeably called the primary cell, i.e., the PCell, or Primary Serving Cell (PSC). Similarly the secondary serving cell is interchangeably called the Secondary Cell (SCell) or Secondary Serving Cell (SSC). Regardless of the terminology, the PCell and SCell(s) enable the UE to receive and/or transmit data. More specifically, the PCell and SCell exist in downlink and uplink for the reception and transmission of data by the UE. The remaining non-serving cells on the PCC and SCC are called neighbor cells.

The CCs belonging to the CA may belong to the same frequency band, a.k.a. intra-band CA, or to different frequency band, i.e., inter-band CA, or any combination thereof, e.g., 2 CCs in band A and 1 CC in band B. Furthermore, the CCs in intra-band CA may be adjacent or non-adjacent in frequency domain, i.e., intra-band non-adjacent CA. A hybrid CA comprising of intra-band adjacent, intra-band non-adjacent and inter-band is also possible. Using carrier aggregation between carriers of different technologies is referred to as “multi-Radio Access Technology (RAT) carrier aggregation” or “multi-RAT-multi-carrier system” or simply “inter-RAT carrier aggregation”. For example, the carriers from Wideband Code Division Multiple Access (WCDMA) and LTE may be aggregated. Another example is the aggregation of LTE and CDMA2000 carriers. For the sake of clarity, carrier aggregation within the same technology can be called ‘intra-RAT’ or simply ‘single RAT’ carrier aggregation.

The CCs in CA may or may not be co-located in the same site, Base Station (BS), or radio network node, e.g., relay, mobile relay, etc. . . . . For instance, the CCs may originate at different locations, e.g., from non-located BS or from BS and Remote Radio Head (RRH) or the Remote Radio Unit (RRU). The well-known examples of combined CA and multi-point communication are Distributed Antenna System (DAS), RRH, RRU, Coordinated MultiPoint transmission (COMP), multi-point transmission/reception, etc. . . . . Embodiments herein also apply to multi-point carrier aggregation systems. The multi-carrier operation may also be used in conjunction with multi-antenna transmission. For example, signals on each CC may be transmitted by the eNB to the UE using two or more antennas.

By applying resource restrictions to the macro layer, the available macro capacity is reduced. The amount of capacity loss is somewhat determined by the blanking ratio. The blanking ratio is the total number of protected subframes over the total number of subframes within a radio frame of 10 ms. The higher the ratio, the higher is the capacity loss in the macro layer. The number of protected subframes, or the blanking ratio, is usually calculated by the macro node or in other network nodes, such as the Operation and Maintenance (OAM) system which then configures the macro node with the established pattern. The blanking pattern is then distributed to the low power nodes within the macro node's coverage area via the “ABS Information” IE in a dedicated X2: LOAD INFORMATION message, provided that the low power nodes have invoked allocation of protected resources to the interfering macro node via the “Invoke Indication” IE in a previously dedicated X2: LOAD INFORMATION message. Low power nodes are thus informed of which subframes are interference protected by the macro node and can schedule their users, e.g., CRE users, on those protected subframes.

Resource restrictions may thus negatively affect the overall running of the communications system.

### SUMMARY

It is therefore an object of embodiments herein to provide a way of improving the managing of time-frequency resources in a wireless network.

According to a first aspect of embodiments herein, the object is achieved by a method in a first node for managing time-frequency resources. The first node is comprised in a wireless network. The first node serves at least one user equipment operating in the wireless network. The first node determines one of: a blanking ratio of a low interference time-frequency resource pattern, and an amount of required protected time-frequency resources. The determining is based on one or more parameters related to the at least one user equipment served by the first node. The determining is for recommending to a second node. The second node is comprised in the wireless network, and uses the low interference time-frequency resource pattern. The first node signals to the second node information. The information comprises at least one of: the determined blanking ratio of the low interference time-frequency resource pattern, the determined required amount of protected time-frequency resources, and the one or more parameters. The at least one user equipment served by the first node receives interference from the second node.

According to a second aspect of embodiments herein, the object is achieved by a method in the second node for managing time-frequency resources. The second node is comprised in the wireless network. The second node receives information from the first node comprised in the wireless network. The information comprises at least one of: the blanking ratio of the low interference time-frequency resource pattern, the required amount of protected time-frequency resources, and the one or more parameters related to the at least one user equipment served by the first node. The low interference time-frequency resource pattern is used by the second node. The blanking ratio of the low interference time-frequency resource pattern is determined by the first node based on the one or more parameters and is recommended by the first node. The required amount of protected time-frequency resources is determined by the first node based on the one or more parameters and is recommended by the first node. The second node adapts the low interference time-frequency resource pattern used by the second node, based on the received information. The least one user equipment served by the first node operates in the wireless network and receives interference from the second node.

According to a third aspect of embodiments herein, the object is achieved by the first node for managing time-frequency resources. The first node is configured to be comprised in the wireless network. The first node is configured to serve the at least one user equipment configured to operate in the wireless network. The first node comprises a determining circuit configured to determine one of: a blanking ratio of the low interference time-frequency resource pattern, and an amount of required protected time-frequency resources. The determining circuit is configured to determine based on one or more parameters related to the at least one user equipment configured to be served by the first node. To determine is for recommending to the second node comprised in the wireless network. The second node is configured to use the low interference time-frequency resource pattern. The signalling circuit is configured to signal information to the second node. The information comprising at least one of: the determined blanking ratio of the low interference time-frequency resource pattern, the determined required amount of protected time-frequency resources, and the one or more parameters. The at least one user equipment is configured to be served by the first node and receives interference from the second node when in operation.

According to a fourth aspect of embodiments herein, the object is achieved by the second node for managing time-frequency resources. The second node is configured to be comprised in the wireless network. The second node comprises a receiving circuit configured to receive information from the first node. The first node is configured to be comprised in the wireless network. The information comprises at least one of: the blanking ratio of the low interference time-frequency resource pattern, the required amount of protected time-frequency resources, and the one or more parameters related to the at least one user equipment. The user equipment is configured to be served by the first node. The low interference time-frequency resource pattern is configured to be used by the second node. The blanking ratio of the low interference time-frequency resource pattern is configured to be determined by the first node based on the one or more parameters. The blanking ratio of the low interference time-frequency resource pattern is also configured to be recommended by the first node. The required amount of protected time-frequency resources is configured to be determined by the first node based on the one or more parameters and configured to be recommended by the first node. The second node comprises an adapting circuit configured to adapt the low interference time-frequency resource pattern configured to be used by the second node, based on the received information. The at least one user equipment configured to be served by the first node is configured to operate in the wireless network and receives interference from the second node when in operation.

By having the first node, that is the node serving the interfered user equipments, signalling the determined blanking ratio of the low interference time-frequency resource pattern, the determined required amount of protected time-frequency resources, and/or the one or more parameters to the second node, the second node may adapt the low interference time-frequency resource pattern used by the second node, based on the received information. Thus, an improved method to manage interference while optimizing the capacity of a wireless system during inter-cell interference coordination is provided, which in turn improves subscriber satisfaction.

### BRIEF DESCRIPTION OF THE DRAWINGS

The accompanying drawings, which are included to provide a further understanding of the disclosure and are incorporated in and constitute a part of this application, illustrate certain non-limiting embodiment(s). In the drawings:

FIG. 1 is a diagram depicting an exemplary macro eNB, i.e., aggressor node, and pico eNB, i.e., victim node system and the signaling exchange these nodes may utilize to exchange information.

FIG. 2 illustrates a schematic block diagram of a wireless communications network, according to some embodiments.

FIG. 3 is a flowchart depicting embodiments of a method in the first radio node, according to some embodiments.

FIG. 4 is a diagram detailing the exchange of information between a second, i.e. macro, node and a first, i.e. pico, node and the steps taken to achieve the desired configuration of protected time-frequency resources.

FIG. 5 is a flowchart depicting embodiments of a method in a second node, according to some embodiments.

FIG. 6 is a block diagram of a first node that is configured according to some embodiments.

FIG. 7 is a block diagram of a second node that is configured according to some embodiments.

### DETAILED DESCRIPTION

In this disclosure, the terms low power node, small cell node, and victim node all refer to the node hosting the cell that is subject to interference by other surrounding cells/UEs. Such nodes might not necessarily be a pico node or similar low power node.

Similarly, the terms aggressor node and high power node all refer to the node hosting the cell generating interference to other surrounding nodes/UEs. Such nodes may not necessarily be a macro node or similar high power node.

As part of the solution according to embodiments herein, one or more problems that may be associated with use of at least some of the prior art solutions will first be identified and discussed.

The eICIC described in the background section requires pico cells to request ABS allocation from macro cells. While this does help eliminate some Inter-cell interference, macro cells can easily over allocate ABSs, thereby unnecessarily reducing their capacity. It is therefore an object of this invention to address some of the problems outlined below, and to provide a solution that enables ABS allocation but does not unnecessarily reduce capacity in macro cells.

One potential issue with resource partitioning is that the aggressor node may assign an excessive number of blank subframes, thereby losing capacity unnecessarily. Excessive blank subframes may be scheduled because the macro node receives a report over X2, see ABS Status IE contained in X2: RESOURCE STATUS UPDATE messages in TS36.423, from the low power node about the protected resources that are usable to the low power node. This report may indicate a low utilization of protected resources by the low power node. This may be due to other neighboring cells interfering with the low power node on protected subframes already allocated by the macro node. As the macro node is unaware of the traffic situation caused by neighbor cells, especially in the CRE areas of the low power nodes, the macro node may decide to allocate more protected resources to the low power nodes in order to achieve a higher utilization of protected resources. However, low utilization of protected resources by low power nodes may not be due to insufficient protected resources allocation by the macro node, but to lack of coordination between interfering macro nodes with regards to protected subframe allocation.

Similarly, a macro node could be allocating too few protected subframes, or it may be transmitting at too high power on the already allocated protected subframes. It might happen that the allocated protected subframes are mostly utilized by the pico node, i.e, the “Usable ABS Pattern Info” IE will show a maximum percentage of used ABS resources. However, the macro node would not be aware of whether more protected subframes are needed at the low power node to properly serve its UEs. If the transmission power used on protected subframes by the macro node is too high, this might result in some of those subframes being flagged as unusable by the low power node or it might result in these subframes being flagged as usable, but unsuitable for the pico served UEs with the most severe interference conditions. In that case, it may not be due to neighbor cell interference at all, but simply high interference generated by the macro node within the protected subframes. A way to approach this issue may be to reduce the number of protected subframes rather than allocating more protected subframes.

In the following paragraphs, different aspects will be described in more detail with references to certain embodiments and to accompanying drawings. For purposes of explanation and not limitation, specific details are set forth, such as particular scenarios and techniques, in order to provide a thorough understanding of the different embodiments. However, other embodiments that depart from these specific details may also exist.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while embodiments herein are primarily described in the form of methods and nodes, they may also be embodied in a computer program product as well as in a system comprising a computer processor and a memory coupled to the processor, wherein the memory is encoded with one or more programs that may perform the functions disclosed herein.

Embodiments will now be described more fully hereinafter with reference to the accompanying drawings, in which examples of the claimed subject matter are shown. The claimed subject matter may, however, be embodied in many different forms and should not be construed as limited to the embodiments set forth herein. Rather, these embodiments are provided so that this disclosure will be thorough and complete, and will fully convey the scope of the claimed subject matter to those skilled in the art. It should also be noted that these embodiments are not mutually exclusive. Components from one embodiment may be tacitly assumed to be present/used in another embodiment.

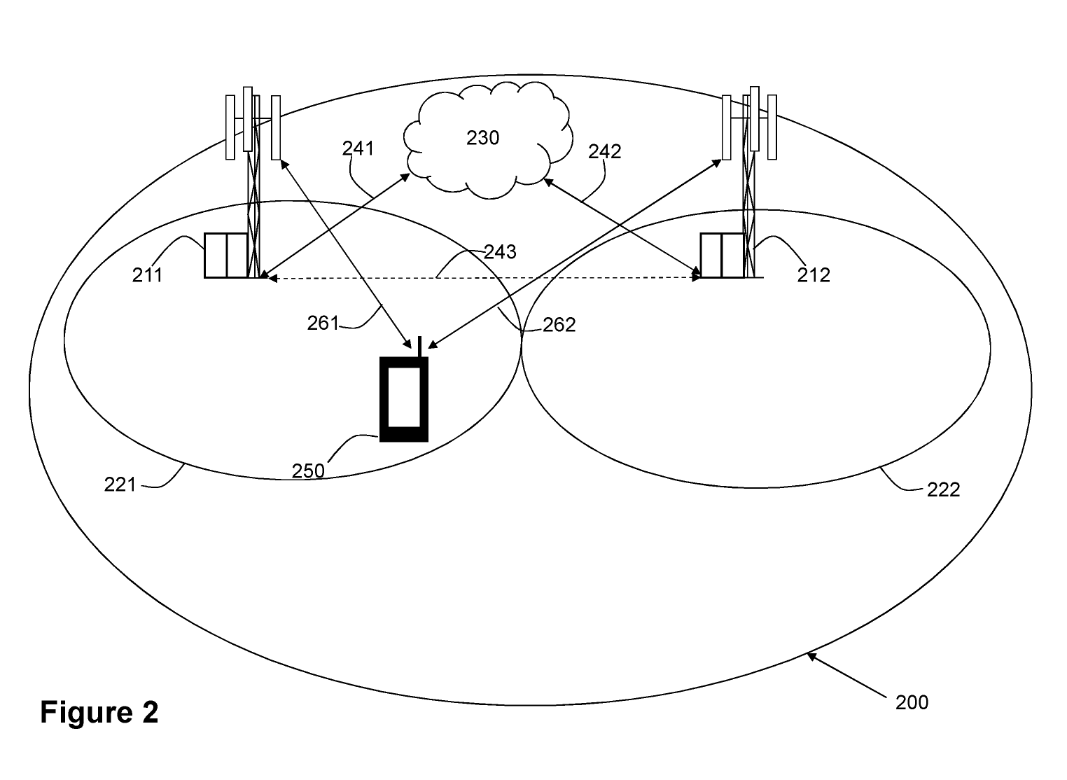

FIG. 2 depicts a wireless network 200 in which embodiments herein may be implemented. The wireless network 200 may for example be a network such as a Long-Term Evolution (LTE), e.g. LTE Frequency Division Duplex (FDD), LTE Time Division Duplex (TDD), LTE Half-Duplex Frequency Division Duplex (HD-FDD), Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Worldwide Interoperability for Microwave Access (WiMax), or any cellular network or system.

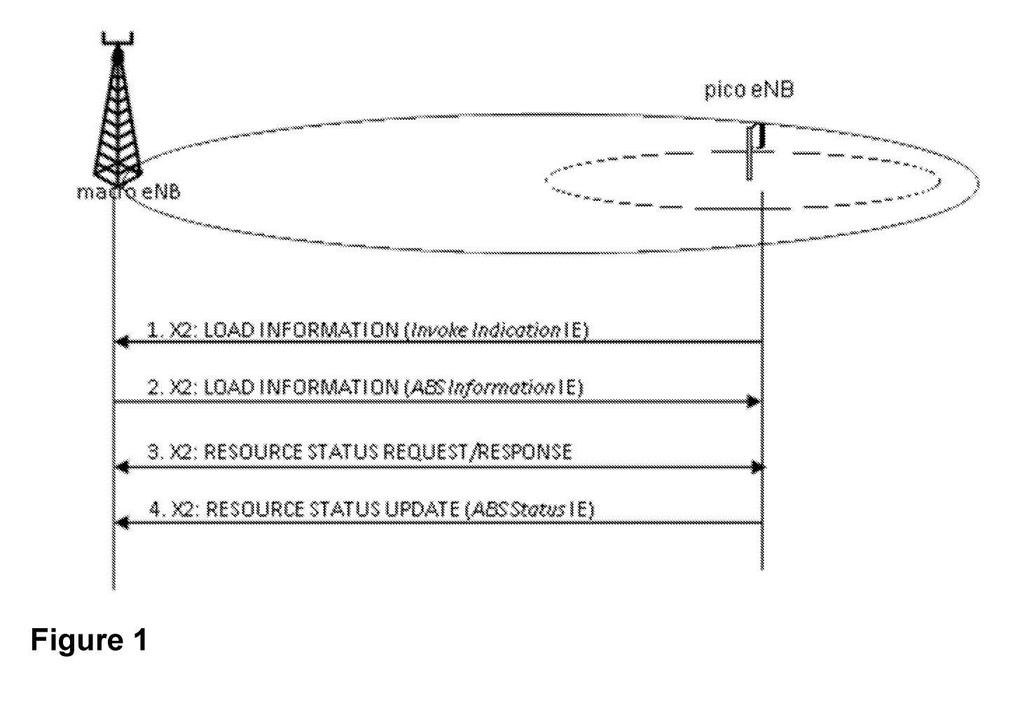

The wireless network 200 comprises a first node 211 and a second node 212. Each of the first node 211 and the second node 212 may be, for example, base stations such as e.g., an eNB, eNodeB, or a Home Node B, a Home eNode B, femto Base Station, BS, pico BS or any other network unit capable to serve a device or a machine type communication device in a wireless network 200. In some particular embodiments, the first node 211 or the second node 212 may be a stationary relay node or a mobile relay node. The wireless network 200 covers a geographical area which is divided into cell areas, wherein each cell area is served by a network node, although, one network node may serve one or several cells. In the examples depicted in FIG. 2, the first node 211 serves a first cell 221, and the second node 212 serves a second cell 222. Each of the first node 211 and the second node 212 may be of different classes, such as e.g. macro eNodeB, home eNodeB or pico base station, based on transmission power and thereby also cell size. Typically, wireless network 200 may comprise more cells similar to 221 and 222, served by their respective network nodes. This is not depicted in FIG. 2 for the sake of simplicity. Each of the first node 211 and the second node 212 may support one or several communication technologies, and its name may depend on the technology and terminology used. In 3GPP LTE network nodes such as the first node 211 and the second node 212, which may be referred to as eNodeBs or even eNBs, may be directly connected to one or more networks 230, e.g., core networks or the internet. The first node 211 may communicate with the one or more networks 230 over a link 241. The second node 212 may communicate with the one or more networks 230 over a link 242. The first node 211 may communicate with the second node 212 over a radio link 243. Embodiments are described in a non-limiting general context in relation to an example LTE scenario with the first node 211 being a macro node and the second node 212 being pico node, as illustrated in FIG. 1. However, it should be noted that the embodiments may be applied to any layered radio access network technology supporting Inter-Cell Interference Coordination (ICIC). Furthermore, in a general case, the macro, and pico cells, i.e., the first cell 221 and the second cell 222, respectively, may correspond to different Radio Access Technologies, such as femto cells, etc. Any reference to “a” or “the” “victim node”, “small cell node”, “low power node” or “victim low power node” herein, is to be understood to apply to the first node 211, or to similar nodes, if in the plural form. Any reference to “an” or “the” “aggressor node”, “high power node”, “aggressor macro node” or “macro node” herein, is to be understood to apply to the second node 212, or to similar nodes, if in the plural form. Similarly, any reference to “a” or “the” “victim cell” herein, is to be understood to apply to the first cell 221, or to similar cells, if in the plural form. Any, any reference to “an” or “the” “aggressor cell” herein, is to be understood to apply to the second cell 222, or to similar cells, if in the plural form.

A number of wireless devices are located in the wireless network 200. In the example scenario of FIG. 2, only one wireless device is shown, user equipment 250. Any reference to a “user”, “users” or “UE” herein is meant to comprise a reference to the user equipment 250, indistinctively, unless noted otherwise. The user equipment 250 may communicate with the first node 211 over a radio link 261, and with the second node over a radio link 262.

The user equipment 250 is a wireless communication device such as a UE which is also known as e.g. mobile terminal, wireless terminal and/or mobile station. The device is wireless, i.e., it is enabled to communicate wirelessly in a wireless communication network, sometimes also referred to as a cellular radio system or cellular network. The communication may be performed e.g., between two devices, between a device and a regular telephone and/or between a device and a server. The communication may be performed e.g., via a RAN and possibly one or more core networks, comprised within the wireless network.

The user equipment 250 may further be referred to as a mobile telephone, cellular telephone, or laptop with wireless capability, just to mention some further examples. The user equipment 250 in the present context may be, for example, portable, pocket-storable, hand-held, computer-comprised, or vehicle-mounted mobile devices, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) devices, devices equipped with a wireless interface, such as a printer or a file storage device or any other radio network unit capable of communicating over a radio link in a cellular communications system. Further examples of different wireless devices, such as the user equipment 250, that may be served by such a system include, modems, or Machine Type Communication (MTC) devices such as sensors.

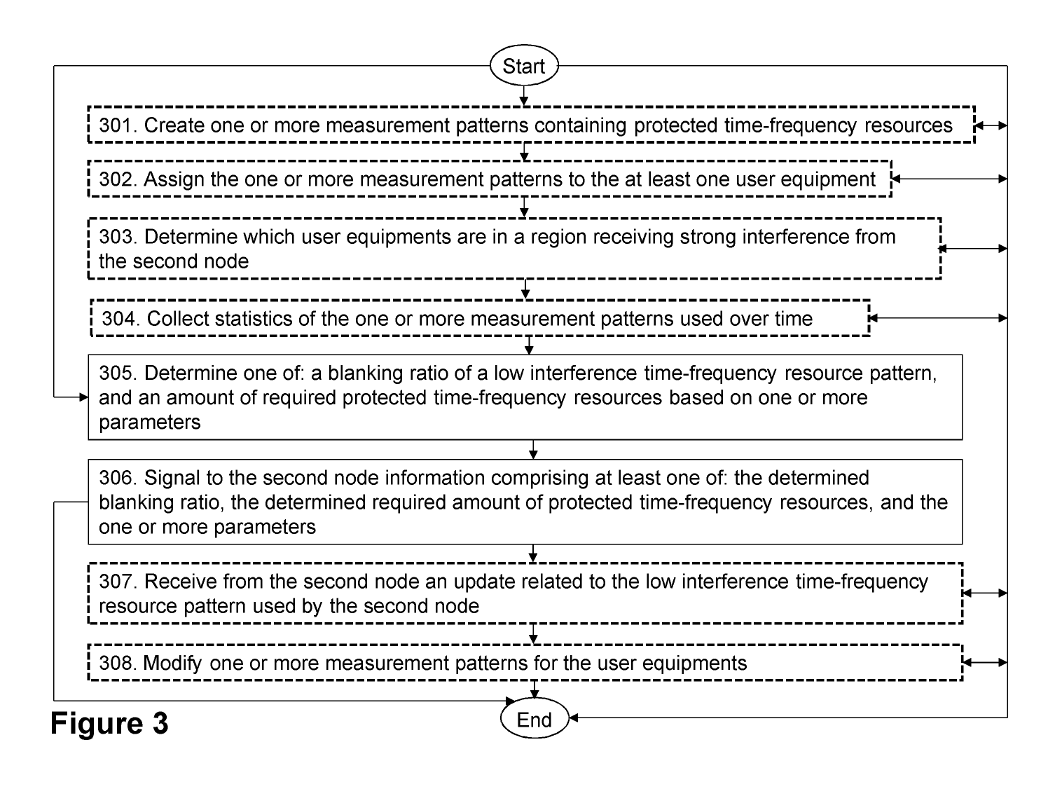

Example of embodiments of a method in a first node 211 for managing time-frequency resources, will now be described with reference to a flowchart depicted in FIG. 3. The first node 211 is comprised in the wireless network 200. The first node 211 serves the at least one user equipment 250 operating in the wireless network 200. The at least one user equipment 250 served by the first node 211 receives interference from the second node 212.

Time-frequency resources refer herein to, e.g., certain RBs in certain time slots or subframes.

In some embodiments, the method of managing resources may be to reduce capacity loss during inter-cell interference coordination in a victim network node operating in a heterogeneous wireless network.

The method comprises the following actions, which actions may be taken in any suitable order. Dashed lines of some boxes in FIG. 3 indicate that the action is not mandatory.

Action 301

This is an optional action. In this action, the first node 211 may create one or more measurement patterns, as described earlier, containing protected time-frequency resources, to enable the at least one user equipment 250 served by the first node 211 to perform measurements on protected resources. The protected time-frequency resources overlap resources in the low interference time-frequency resource pattern used by the second node 212. The creating may be implemented, for example by first node 211 for each user equipment 250 connected to it. In order to decide whether patterns are required for certain UE or not, the first node 211 may take into account the location of the UE with respect to the first node 211 and second node 212. The UE location may be determined for example based on radio measurements performed by the UE on serving and neighbouring cells. The patterns may be stored in the memory of the first node 211 and may be signalled to the UE when configuring the UE for certain procedure involving patterns, e.g., when the UE is required to perform radio measurement on serving and/or neighbouring cells.

In some embodiments, the low interference time-frequency resource pattern may be one of: an Almost Blank Subframe pattern, and a signal transmit pattern comprising low interference time-frequency resources.

A measurement pattern may be used to enable a victim user, especially CRE users, to perform measurements, e.g., mobility measurements, CSI measurements, etc. . . . on protected resources, i.e. protected from aggressor cell interference. Users may be assigned multiple patterns for measurements. For example, there may be one pattern for neighboring cell measurements, one for CSI measurements to be performed in normal subframes, i.e., unprotected subframes, and another one for CSI measurements in protected subframes, etc. . . . . CSI measurements performed in normal and protected subframes are termed as the first type and second type of CSI measurements, respectively. Thus, serving network nodes, i.e. victim pico eNB, etc. . . . assigning the measurement patterns to the UEs, such as the user equipment 250, as described in action 302, may be aware of the measurement patterns being used by the UEs. This may enables the serving network node to collect statistics of the measurement pattern used over time to determine the amount of the protected resources utilized or required by the users. The serving network node may typically schedule users in protected resources. Therefore, it may also collect statistics regarding the utilization of protected resources for scheduling data and/or control information to the victim users, as described later in action 304.

Action 302

This is an optional action. In this action, the first node 211 may assign the one or more measurement patterns to the at least one user equipment 250 served by the first node 211, as described above. For example, the measurement pattern may be communicated to the user equipment 250 via RRC signaling in the RRC_CONNECTED state.

Action 303

This is an optional action. In the embodiments in which the first node 211 serves more than one user equipment 250, the first node 211 may determine which user equipments 250 served by the first node 211 are in a region served by the first node 211 receiving strong interference from the second node 212, i.e., the CRE region.

The CRE region may contain users which are closer to the aggressor node, i.e. high power node, macro node, etc. . . . , and thus may receive strong interference from the aggressor node. To determine which users may be in the CRE region of a victim cell, several methods may be employed. In one example, users in the CRE region of the victim cell may be all those users with signal quality in the xth percentile, e.g., 10th percentile, or the bottom 10 percent in terms of their serving cell signal quality, relative to all users served by the victim cell. In another example, users whose signal quality with respect to the serving cell, such as the first cell 211, i.e., the cell served by the victim node, is below a threshold may be considered users in the CRE region of the victim cell. In yet another example, users of the victim cell that may receive interference from an aggressor cell above a certain threshold, e.g., Signal to Noise Ratio (SNR) above 2 deciBels (dB), may be considered users in the CRE region of the victim cell. In yet another example, the number of CRE users may be based on relative signal measurements, e.g., RSRP or RSRQ, performed on the signals from the serving cell and a reference cell, e.g., best or strongest cell. For example, if the signal measurement of the reference cell compared to that of the serving cell is above a threshold, e.g., 6 dB, then the user may be considered to be in the CRE region.

Based on the UE traffic in a CRE region, the serving network node, such as the first node 211, e.g., pico eNB may create one or more measurement patterns containing protected time-frequency resources.

Thus, in some embodiments, the determining of which user equipments 250 served by the first node 211 are in a region served by the first node 211 receiving strong interference from the second node 212, i.e., the CRE region, may be based on one of: a. user equipments 250 whose signal quality with respect to the serving cell 221 served by the first node 211 is below a threshold; and b. at least one relative signal measurement comparing measurements performed on signals from the serving cell 221 and a reference cell.

In these embodiments, the creating one or more measurement patterns may be based on traffic of the determined user equipments 250 in the region.

Action 304

In this action, the first node 211 may collect statistics of the one or more measurement patterns used over time, e.g., the average number of users, percentage of users, etc. . . . . This is an optional action. This may be implemented, for example by the first node 211 maintaining a multi-dimensional lookup table in its memory. For example, the lookup table may map the parameters associated with each pattern, time duration of its usage and identifier of the UE that used the pattern. The first node 211 may also maintain the list of all UEs served over certain time period. From the lookup table and the information about the UEs served by the first node 211, the desired statistics may be determined, e.g., percentage of users that used certain type of pattern over certain time. The statistics may be used by the first node 211 or by any other node to determine which patterns are more commonly used. For example, such information may be used for recommending the blanking ratio of low interference time-frequency resources in the second node 212.

Action 305

The first node 211 determines one of: a blanking ratio of a low interference time-frequency resource pattern, and an amount of required protected time-frequency resources. In these embodiments, the determining is based on one or more parameters related to the at least one user equipment 250 served by the first node 211. The determining is for recommending to the second node 212 comprised in the wireless network 200 using the low interference time-frequency resource pattern. Recommending may comprise for example, signalling a request or a target, e.g. value, such as for example a target blanking ratio. Signalling may be implemented as described below in reference to action 306. For example, signalling may comprise an indicator, or an additional Information Element (IE). Either may be sent to the second node 212 in a higher layer signalling message, such as a message sent over the X2 interface, e.g., a RESOURCE STATUS UPDATE message, as shown in Table 1. The decision to modify the low interference time-frequency resource pattern may then depend upon the second node 212. That is, it may be up to the second node 212 to decide whether to modify the low interference time-frequency resource pattern as requested by the first node 211 or not.

In some embodiments, the blanking ratio of the low interference time-frequency resource pattern may comprise one or more of: a. a number of low interference time-frequency resources in the low interference time-frequency resource pattern; b. a ratio of low interference time-frequency resources to a total number of time-frequency resources during a radio frame.

In some embodiments, as described below, the one or more parameters may comprise: user equipment 250 statistics in a cell range expansion region, i.e., CRE region, of a cell 221 served by the first node 211, user equipment 250 statistics regarding the one or more patterns of protected time-frequency resources in the cell 221 served by the first node 211, user equipment 250 traffic in the cell 221 served by the first node 211, utilization of protected resources in the cell 221 served by the first node 211, and density of protected time-frequency resource patterns used in the first node 211.

In some embodiments the first node 211 may determine the blanking ratio of low interference, protected, time-frequency resources in aggressor network nodes, such as the second node 212, e.g., macro nodes. Some embodiments may comprise a victim network node, such as the first node 211, determining a recommended blanking ratio or desired amount of protected resources or an increase/decrease in the protected resource power. Some embodiments may further comprise determining a desired amount/power of protected resources in a victim network node, such as the first node 211.

The first node 211, in some embodiments the victim node, e.g., pico eNB, micro eNB, etc., may use one or more parameters to derive the information necessary for recommending blanking ratios or recommending a desired amount/power of low interference time-frequency resources to the second node 212. Typically, the victim node may serve users which require protected resources for performing radio measurements, e.g., CSI, RLM, cell identification, signal measurements such as RSRP/RSRQ, UE Rx-Tx time difference measurements, etc., and/or receiving physical channels, e.g., data, control information, etc. . . . . The victim node may also be a high power node, e.g., macro eNB, if its users are interfered with by, for example, another high power node or a Closed Subscriber Group (CSG) node, etc. . . . . Examples of some potential parameters may include:
User statistics in the CRE region of a cell, such as the first cell 211, served by the victim node, e.g., average number of users, percentage of users, etc. . . . ;
User statistics regarding one or more patterns of protected time-frequency resources in the cell, such as the first cell 211, served by the victim node, e.g., the average number of users, percentage of users, etc. . . . ;
User traffic, e.g., buffer size of CRE users, buffer size of users utilizing patterns of protected time-frequency resources;
Utilization of protected resources, e.g., amount of data scheduled in protected resources, percentage of protected resource used, etc. . . . ;
Density of protected time-frequency resource patterns used in the victim node, e.g., number of restricted subframe(s) per frame in a measurement pattern typically signaled to the users.

According to one embodiment, the victim network node may signal implicit information comprising one or more parameters related to the use of protected resources to the aggressive network node, as described in action 306. In an alternative embodiment, the victim network node may first derive more explicit information, e.g., recommended value of blanking ratio of protected resources required at the victim node. This recommended value may be based on one or more of the parameters described above. For example, if the number of subframes used for the second type of CSI measurements is a subset of the usable low interference subframes in a blanking pattern, i.e. the ABS pattern used by an aggressor cell, then it may mean that not all protected subframes are being used. In that case, the victim node may assume that the blanking ratio is higher than required. On the other hand, if the number of protected subframes matches the low interference subframes used in the blanking pattern and the victim node is in need of more resources for users in the CRE region, then the victim node may conclude that the current blanking ratio in the aggressor cell may be lower than the actual requirement by the victim cell.

The victim node may also determine an adequate blanking ratio in the aggressor cell based on the outstanding traffic of the users, the users in the CRE region, or the users which are assigned one or more measurement patterns. For example, if the traffic in the buffer is above a threshold for at least some number N, or xth percent, e.g., 50%, of such users, then the victim may assume that the current blanking ratio is insufficient. But if the outstanding traffic is below a threshold for most of the users, e.g., 70%, then the victim node may assume that the blanking ratio used by the aggressor cell is too high.

The victim node may also combine more than one criterion to decide the recommended value of the blanking ratio. For example, to improve reliability of the recommended blanking ratio, the victim node may recommend lowering the blanking ratio provided that outstanding traffic is below a threshold and the number of protected subframes in the measurement pattern is less than the low interference subframes in the blanking pattern. Thus, the low power node, such as the first node 211, may take this information into account as part of the information to be signaled to the macro node. The victim node then signals the derived blanking ratio or a similar parameter to the aggressor node.

Action 306

The first node 211 signals information to the second node 212. The information comprises at least one of: the determined blanking ratio of the low interference time-frequency resource pattern, the determined required amount of protected time-frequency resources, and the one or more parameters.

In certain embodiments, victim network node(s), such as the first node 211, and an aggressor network node, such as the second node 212, may exchange information, wherein at least one low power node, such as the first node 211, may signal a correction factor related to the blanking ratio, or a recommended value to the second node 212, i.e., the aggressor node, e.g., a macro node, based on locally acquired information. The local information may comprise the number of users, such as user equipment 250, in a CRE area, their activity level, their resource utilization, and patterns of those users, e.g., restricted pattern for measurements, scheduling pattern, etc. . . . . The victim network node, such as the first node 211, may signal information related to the recommended blanking ratio to an aggressor node, such as the second node 212.

The signaling between a victim node, e.g., low power node such as a pico eNB, and an aggressor node, e.g., macro node such as a macro eNB, to exchange implicit or explicit information regarding the blanking ratio and/or protected time-frequency resources used by the aggressor node is further described herein. In the implicit case, the aggressor node may derive an appropriate blanking ratio for a blanking pattern. In both implicit and explicit cases, the aggressor node may consider information from multiple victim nodes when updating the blanking ratio of the blanking pattern. The embodiments herein are described using several examples of signaling messages pertaining to the blanking ratio of blanking patterns. One skilled in the art will appreciate, however, that embodiments are not limited to these specific examples.

In a first embodiment, signaling may consist of additional Information Elements (IEs) on the X2: RESOURCE STATUS UPDATE message, e.g., part of the “ABS Status” IE, as shown in Table 1. One of these IEs may be an indication of protected resource utilization increase or decrease. Specifically, the low power node, such as the first node 211, may indicate to the aggressor node how much the interference on already allocated subframes needs to be reduced, e.g., where a UE is suffering poor performance, or how the resources are currently being underutilized, e.g., where UE performance is above certain thresholds. Table 1 shows an example of one potential IE, called a “Utilization Change Request” therein. Note that this new information may be most suitable for making adjustments to already allocated protected subframes by the macro, e.g., aggressor, node. In Table 1, this new information has been indicated as an “integer (−20 . . . 20),” i.e., as an integer value showing the amount of increase/reduction in dBs. However, the information may also be provided by an increase or decrease indication.

In conjunction with the IE described above, another enhancement may be a new IE called the “Protected Resources Change Request” described in Table 1. This could indicate a request for an increase or decrease in the overall protected resources both in the time domain and/or in the frequency domain. This new IE may be interpreted by the macro node as an indication to increase or decrease the allocation of protected subframes.

The information above can either be complemented or be replaced with one or more other IEs that indicate the overall amount of protected subframes needed by the low power node, such as the first node 211, to serve its UEs with an adequate quality of service. As an example, in Table 1, this new IE is called the “Target Blanking Ratio” IE and it represents the target blanking ratio calculated by the victim node as specified above.

Taking Table 1 as a possible example of how the enhancements proposed in this embodiment may be implemented, the macro node receiving the enhanced X2: RESOURCE STATUS UPDATE message may react by:
Upon receipt of the “Utilization Change Request” IE, increasing or decreasing the downlink transmission power in the already allocated protected subframes; either by the amount reported in the message or according to the indication received.
Upon receipt of the “Protected Resources Change Request” IE, increasing or decreasing the allocation of protected subframes based on the information in the IE.
Upon receipt of the “Target Blanking Ratio” IE, achieving an optimal amount of protected resources, i.e., the optimal blanking ratio, based on the information received in the IE.

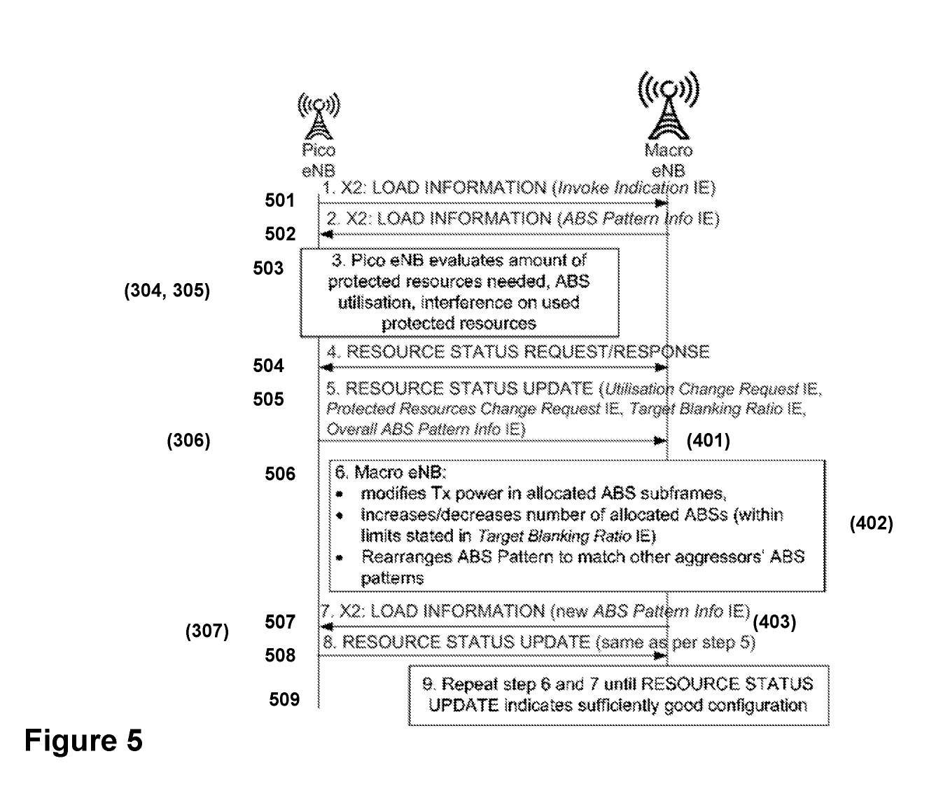

In a second embodiment, illustrated in FIG. 5, the information described in the first embodiment and shown in the example in Table 1 may be used in combination with information about the overall protected resources allocated to the low power node, such as the first node 211, by other aggressor macro nodes, similar to the second node 212. In fact, it is worth highlighting that the “Usable ABS Pattern Info” IE currently specified in TS36.423 only refers to the ABS subframes usable by the victim low power node, such as the first node 211, that may have been assigned by the aggressor macro node receiving the X2: RESOURCE STATUS UPDATE message. In other words, the usable ABS subframes indicated via the “Usable ABS Pattern Info” IE may be contained in the ABS pattern allocated by only one aggressor, i.e. the aggressor receiving the IE over X2. However, if the aggressor macro node, such as the second node 212, is to understand how to better coordinate ABS allocation with other neighbor macro aggressors, similar to the second node 212, it may be useful if the “Usable ABS Pattern Info” IE may also express information about the usable ABSs allocated by all aggressor macro nodes affecting the victim node.

This exemplary second embodiment may be achieved by changing the semantics of the “Usable ABS Pattern Info” IE contained in the “ABS Status” IE shown in Table 2. By removing the condition that the ABS subframes usable by a low power node, similar to the first node 211, must be assigned by the node receiving the X2: RESOURCE STATUS UPDATE message, it is possible to provide the macro node, such as the second node 212, with a full view of the ABS subframes utilized by the low power node, e.g., the first node 211, even if these were allocated by a different aggressor. This is indicated on Table 2, with strikethrough text.

Additionally, a new IE may be foreseen, which as a matter of example may be named the “Overall ABS Pattern Info” IE as indicated in Table 2. This IE may indicate the overall pattern of ABSs allocated to the low power node, such as the first node 211, by all aggressor nodes that may be affecting UEs in the victim node.

Using the modified “Usable ABS Pattern Info” IE and the new “Overall ABS Pattern Info” IE described above, an aggressor macro node may be able to understand which ABS subframes are usable by the low power node, independently of the aggressor, and which subframes have been allocated as ABS by neighboring aggressor nodes. Because the macro node may know the ABS pattern allocated by itself to the particular low power node, such as the first node 211, the macro node, such as the second node 212, may understand whether there is a lack of coordination among the neighboring macro nodes, similar to the second node 212. Thus, the macro node may re-arrange its ABS pattern so as to substantially match the ABS patterns of other aggressor nodes, thereby minimizing wasted resources.

Thus, in some particular embodiments, the information signalled to the second node may comprise at least one of: an indication of increase or decrease of utilization of allocated protected resources, an indication to increase or decrease an allocation of protected resources, an indication of a target amount of protected resources needed, an indication of usable protected resources allocated by all nodes generating interference affecting the first node 211, and an indication of an overall amount of protected resources allocated by all nodes generating interference affecting the first node 211.

Action 307

In this action, the first node 211 may receive from the second node 212 an update related to the low interference time-frequency resource pattern used by the second node 212. This is an optional action. As described below in relation to action 403, this may be implemented for example by means of X2: LOAD INFORMATION message.

Action 308

In some embodiments, the first node 211 may modify one or more measurement patterns for the user equipments 250 served by the first node 211, based on the received update. This is an optional action.

In some of these embodiments, the modified one or more measurement patterns may be at least one of: a measurement resource restriction pattern for a primary cell 221, a measurement resource restriction pattern for one or more neighbour cells, and a resource restriction pattern for channel state information measurement of the primary cell 221, as described earlier in reference to Pattern 1, Pattern 2, and Pattern 3, respectively.

The victim, e.g., low power node, node receiving the update from the macro node related to the blanking pattern may accordingly decide to modify one or more measurement patterns for the users under its control. It may also modify other radio parameters as explained further. For example, the victim node, e.g., low power node may increase the number of protected subframes in various measurement patterns if the new ABS configuration contains a larger number of ABS subframes compared to the previous configuration. In another example, the victim node may schedule its users, or at least its CRE users, in a pattern with a power above a certain threshold if the ABS is RP-ABS instead of ZP-ABS in the aggressor node. This may ensure that the UE is able to decode the data and/or control information from the serving cell despite some interference from the aggressor node.

In yet another embodiment, the victim node may modify certain radio parameters related to, for example, measurement configuration depending on the type of ABS and/or blanking ratio used by an aggressor cell. For example, if the modified ABS is RP-ABS in the aggressor node, then the victim node may request a UE to perform measurements over a larger number of cells, e.g., by signaling more cells in the neighbor cell list. In another example, the victim node may configure its time domain filtering parameter with a larger coefficient, a.k.a. layer 3 filtering, to enable a UE to perform more time averaging of the radio measurements performed on the serving and/or neighbor cells. In yet another example, the victim node may also configure the UE to perform measurements on a cell over a larger measurement bandwidth, e.g., over 50 resource blocks instead of 6, to enable the UE to perform frequency domain averaging over larger bandwidth. All of these examples of modified radio parameters will ensure that the UE is able to perform and report more reliable measurement results with better accuracy. This may also enable the UE to report results from a larger number of cells. That, in turn, may improve the radio resource management performance, e.g., cell change.

After modifying the one or more measurement patterns for the user equipments 250 served, based on the received update from the second node 212, the first node 211 may signal a new a resource status update to the second node 212, in a similar manner as how it was described in action 306.

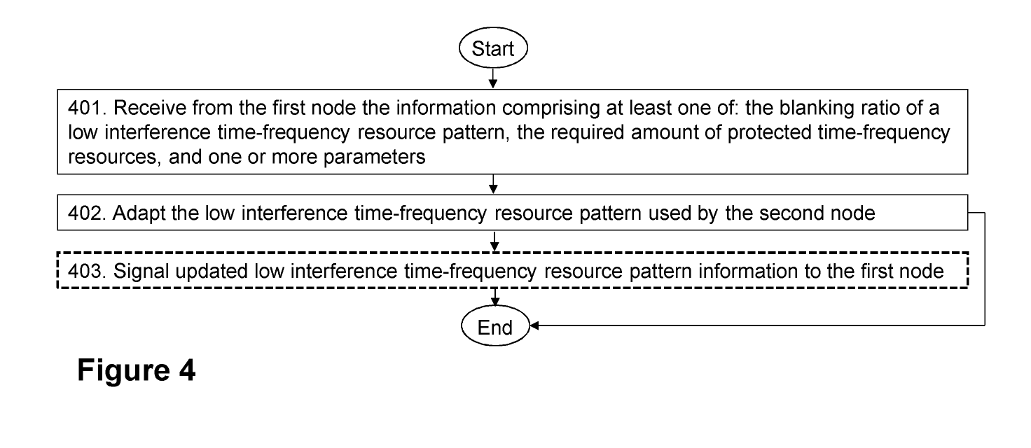

Example of embodiments of a method in a second node 212 for managing time-frequency resources, will now be described with reference to a flowchart depicted in FIG. 4. The second node 212 is comprised in the wireless network 200.

In some embodiments, the method may be a method of managing protected time-frequency resources to reduce capacity loss during eICIC coordination in an aggressor network node of a heterogeneous wireless network.

The method comprises the following actions, which actions may be taken in any suitable order. Dashed lines of some boxes in FIG. 4 indicate that the action is not mandatory.

Action 401

The second node 212 receives the information from the first node 211 comprised in the wireless network 200. As described earlier, the information comprises at least one of: the blanking ratio of the low interference time-frequency resource pattern, the required amount of protected time-frequency resources, and the one or more parameters related to the at least one user equipment 250 served by the first node 211. The low interference time-frequency resource pattern is used by the second node 212. The blanking ratio of the low interference time-frequency resource pattern is determined by the first node 211 based on the one or more parameters and recommended by the first node 211. The required amount of protected time-frequency resources is also determined by the first node 211 based on the one or more parameters and recommended by the first node 211. As stated earlier, the at least one user equipment 250 served by the first node 211 operates in the wireless network 200 and receives interference from the second node 212. The receiving may be implemented as described above in relation to action 306. For example, the signaling may consist of additional Information Elements (IEs) on the X2: RESOURCE STATUS UPDATE message, e.g., part of the “ABS Status” IE, as shown in Table 1.

As described earlier, in some embodiments, the low interference time-frequency resource pattern is one of: an Almost Blank Subframe pattern, and a signal transmit pattern comprising low interference time-frequency resources.

As before, in some of embodiments, the received information from the first node 211 may comprise at least one of: the indication of increase or decrease of utilisation of allocated protected resources, the indication to increase or decrease the allocation of protected resources, the indication of a target amount of protected resources needed, the indication of usable protected resources allocated by all the nodes generating interference affecting the first node 211, and the indication of an overall amount of protected resources allocated by all the nodes generating interference affecting the first node 211

Action 402

The second node 212 adapts the low interference time-frequency resource pattern used by the second node 212, based on the received information.

In some of particular embodiments, adapting may comprise adapting the blanking ratio of the low interference time-frequency resource pattern used by the second node 212, based on the received information.

In some embodiments, adapting may comprise modifying a utilization of the low interference time-frequency resource pattern used by the second node 212, based on the received information.

In some embodiments, adapting may comprise changing a type of the low interference time-frequency resource pattern used by the second node 212, based on the received information.

In some embodiments, the aggressor network node, such as the second node 212, may adapt the blanking ratio according to the information received from the victim network node, such as the first node 211.

The aggressor node may adapt or update the blanking ratio of the blanking pattern or modify the number of protected resources based upon the receipt of implicit or explicit information from the victim nodes regarding recommended blanking ratios, ABS pattern configurations, and/or protected resources utilization. In one embodiment, the aggressor node may increase the blanking ratio, i.e. increase the number of blanked subframes, such as ABS, per frame, if a certain number of surrounding victim nodes, L, requires a higher blanking ratio. In that case, the updated blanking ratio may, for example, be based on a suitable function of the recommended ratios, e.g., the average, maximum, xth percentile, median, etc. . . . . In one embodiment, the modified blanking ratio is the average of the blanking ratios recommended by the L number of surrounding victim nodes.

In an alternative embodiment, the aggressor node may modify the number of protected resources it provides by taking an average of the indications received regarding the requested utilization changes. The aggressor node may also take into account its own traffic situation. For example, if the traffic demand of the aggressor node's users is higher than a certain threshold, the aggressor node may not increase the blanking ratio of the blanking pattern or reduce the amount of protected resources beyond a certain blanking ratio. On the other hand, if several victim nodes, e.g., at least M, where M>L, request an increase in the blanking ratio, or a decrease of protected resource utilization, and traffic requirements of the macro users are too high, then the aggressor node may take appropriate action. Such action may include the aggressor node trying to offload its macro users to another macro node by performing cell change of certain users and/or performing inter-frequency/inter-RAT cell change for a certain number of users. Thus, the aggressor node may reduce its required capacity, thereby allowing the aggressor node to increase the blanking ratio of the blanking pattern, e.g., the ABS pattern used by the aggressor cell, as requested.

While evaluating which action(s) to take, the aggressor node may also consider information regarding the load in the victim cells. This information may be exchanged via the X2: RESOURCE STATUS UPDATE message.

Other embodiments of aggressor node actions are further elaborated below, with examples.

In one embodiment, the extra information described above and applied to the X2: RESOURCE STATUS UPDATE message may be received by the macro node from different low power nodes, similar to the first node 211. Using the enhanced “Usable ABS Pattern Info” IE and the new “Overall ABS Pattern Info” IE described above, or some similar implementation thereof, the macro node may gather an understanding of how neighboring low power nodes, similar to the first node 211, are individually affected by interference from surrounding macro nodes, similar to the second node 212. Also, the macro node may understand how the overall allocated ABS patterns differ among various low power nodes, similar to the first node 211.

Moreover, the macro node may receive indications of how efficient its own ABS pattern configuration is through the “Utilization Change Request” IE, “Protected Resources Change Request” IE, and the “Target Blanking Ratio Pattern” IE.

When receiving multiple indications from different low power nodes, similar to the first node 211, one of the objectives of the macro node may be to receive the same “Usable ABS Pattern Info” IE from all neighboring low power nodes. Also, an optimum configuration may be where the pattern in the “Usable ABS Pattern Info” IE for all neighboring low power nodes, similar to the first node 211, corresponds to the ABS pattern allocated by the macro node and where such pattern also corresponds to the pattern in the “Overall ABS Pattern Info” IE. Said another way, all neighbor macro nodes, similar to the second node 212, may be using the same ABS pattern and the pattern may usable by all neighboring low power nodes, similar to the first node 211.

To achieve the optimal configuration mentioned in the embodiment above, the macro node may decide to change its allocated protected resources and to monitor how the information reported by each low power node in the X2: RESOURCE STATUS UPDATE message are affected. Exemplary changes the macro node may employ include:
Different scheduling policies across all resources, both protected and non-protected. This may reveal how Usable ABS Patterns change for different low power nodes when utilization of resources changes.
Different levels of Transmit Power Levels for allocated ABSs. This may reveal whether the main interference in allocated ABSs is generated by the macro node or by other neighbor macro node aggressors.
Different ABS patterns. This may reveal whether some resources are consistently interfered with by certain neighbor aggressors, similar to the second node 212, and may be avoided for ABS configuration.

When receiving information from the victim low power nodes, the macro node may decide to give different weight to such information. Several factors may be considered when determining what weight to give a piece of information, including:
Proximity of the low power node to the aggressor node, determined for example, by known configurations or macro served UE measurements on the victim cell.
Load and/or Capacity in the cell served by the low power node, acquired by requesting reporting of load and capacity information via the “Report Characteristics” IE sent by the macro node in the X2: RESOURCE STATUS REQUEST message and receiving the X2: RESOURCE STATUS UPDATE message containing load and capacity information from the low power node.
Type and size of neighbor victim cell, the aggressor node may receive information concerning the type and size of the neighbor victim cell.

Information about the type and size of a neighbor victim cell may come, for example, by way of the “Cell Type” IE defined in TS36.413. Furthermore, the aggressor node may be given information regarding PCIs corresponding to closed CSG and hybrid cells. The aggressor node may also, if connected to the victim node via X2, have information regarding the PRACH configuration of the victim node, which may provide information about the size of the cell. All the information above may be used to give different weight to the information received from the victim nodes.

Coordination among different macro nodes may also occur at different nodes in the network. For example, the information reported in the X2: RESOURCE STATUS UPDATE message by different low power nodes may be sent to the OAM system for analysis. The OAM system may choose a configuration for all the macro nodes in a neighborhood that may maximize the performance of the macro and low power nodes.

According to another aspect of this embodiment, the macro node may change the type of low interference time-resource pattern, i.e., type of ABS pattern, based on the information received from the surrounding low power nodes. As detailed above, the ABS pattern may be categorized in different ways, e.g., Zero Power ABS, ZP-ABS, Reduced Power ABS, RP-ABS, Reduced Activity ABS, RA-ABS, or combination of RP-ABS and RA-ABS. It may also be categorized as non-MBSFN and MBSFN. For example, assume a node is currently configured to provide an MBSFN ABS pattern with a blanking ratio of 1/10, one ABS per frame. Based on the information received from at least L neighboring pico nodes, the macro node may need to increase the blanking ratio from 1/10 to 3/10. However, only 2 MBSFN frames may be available for ABS. Therefore, the macro node may decide to change the MBSFN ABS to a non-MBSFN pattern with blanking ratio of 3/10.

In yet another example related to the same scenario, assume the traffic load of macro users, i.e., served by the macro node, using delay sensitive low bit rate unicast services, e.g., speech, is higher than a certain threshold, e.g., at least 100 active users. Due to low bit rate requirements, the users may be served with low transmit power from the serving macro node. In this case, the macro node may configure non-MBSFN RP-ABS with 3/10 blanking ratio, i.e., ABS with reduced power. In this way, the macro node may still serve its own users while being able to protect the surrounding pico nodes, similar to the first node 211.

Action 403

In the some embodiments, the second node 212 may signal updated low interference time-frequency resource pattern information to the first node 211. The updated low interference time-frequency resource pattern information, i.e., updated blanking pattern information, may correspond to information adapted according to the previous action.

For example, in some particular embodiments, the aggressor network node, such as the second node 212, may signal updated low interference time-frequency resource pattern information comprising information related to the updated blanking ratio to the victim node(s), such as the first node 211. In some particular embodiments, the aggressor node may signal updated blanking pattern information to the victim node.

As another example, in some embodiments, the aggressor node, e.g., macro node, may inform one or more surrounding low power nodes, such as the first node 211, that it has updated the blanking ratio of the blanking pattern, i.e. low interference time-frequency resource pattern such as ABS, and/or configured a new type of blanking pattern by means of X2: LOAD INFORMATION message. Thus, in some embodiments updated low interference time-frequency resource pattern information comprises a new type of blanking pattern, i.e., a new type of low interference time-frequency resource pattern.

Thus, in some embodiments, the updated low interference time-frequency resource pattern information may comprise at least one of: the adapted blanking ratio of the low interference time-frequency resource pattern used by the second node (212), and the changed type of the low interference time-frequency resource pattern used by the second node (212).

By having the first node 211, that is, the node serving the interfered user equipments 250, signalling the determined blanking ratio of the low interference time-frequency resource pattern, the determined required amount of protected time-frequency resources, and/or the one or more parameters to the second node 212, i.e., the node generating interference, the second node 212 may adapt or update the blanking ratio of the blanking pattern or modify the number of protected resources based upon the receipt of implicit or explicit information from the victim nodes. Thus, a method is disclosed to ensure that an aggressor network node allocates an adequate number of low interference time-frequency resources, e.g., ABS, to protect corresponding resources in victim nodes, without unnecessarily reducing its capacity. The allocation of low interference time-frequency resources is adapted for managing interference at the users of the first node 211, i.e., victim node. Thus, an improved method to manage interference while optimizing the capacity of a wireless system during inter-cell interference coordination is provided, which in turn improves subscriber satisfaction.

FIG. 5 is a diagram detailing an example of the exchange of information between the second node 212, which in this example is a macro node “Macro eNB”, and the first node 211, which in this example is a pico node “Pico eNB”, and the actions taken to achieve the desired configuration of protected time-frequency resources, as just described in relation to FIG. 3 and FIG. 4.

Action 501. The first node 211 may send an X2. LOAD INFORMATION (Invoke Indication IE) message.

Action 502. The first node 211 may receive an X2. LOAD INFORMATION (ABS Pattern Infor IE) message.

Action 503. The first node 211, i.e., Pico eNB, may evaluate the amount of protected resources needed, ABS utilization, and interference on used protected resources. This action, in some embodiments, corresponds to actions 304, 305 described above.

Action 504. The second node 212 may send a RESOURCE STATUS REQUEST to the first node 211, and the first node 211 may send a RESOURCE STATUS RESPONSE to the second node 212.

Action 505. The first node 211 may send a RESOURCE STATUS UPDATE (Utilisation Change Request IE, Protected Resources Change Request IE, Target Blanking Ratio IE, Overall ABS Pattern Info IE) to the second node 212. This action, in some embodiments, corresponds to action 306 described above. The second node 212 may receive this update, which, in some embodiments corresponds to action 401 described above.

Action 506. The second node 212, i.e., the Macro eNB, may modify TX power in allocated ABS subframes, increase/decrease number of allocated ABSs (within limits stated in Target Blanking Ratio IE) and rearrange ABS Pattern to match other aggressors' ABS patterns. This action, in some embodiments, corresponds to action 402 described above.

Action 507. The second node 212 may send an X2: LOAD INFORMATION (new ABS Pattern Info IE) message to the first node 211. This action, in some embodiments, corresponds to action 403 described above. The first node 211 may receive this message, which, in some embodiments corresponds to action 307 described above.

Action 508. The first node 211 may send a RESOURCE STATUS UPDATE (same as per action 505), to the second node 212.

Action 509. The second node 212 may repeat actions 506 and 507 until RESOURCE STATUS UPDATE indicates sufficiently good configuration.

In this Figure, actions 501 and 502, correspond, respectively, to actions 1 and 2 in FIG. 1, and actions 504 and 505, correspond, respectively, to actions 3, and 4, in FIG. 1, except where further reference is made to actions described herein, i.e., actions 306 and 401.

### Applicability to Other Scenarios

The embodiments above are described in examples where serving eNBs are assumed to be pico eNBs, neighboring eNBs are assumed to be pico and macro eNBs, and aggressor eNBs are assumed to be macro eNBs. However, those embodiments are not limited to pico and macro eNB scenarios.

In another embodiment, the serving eNB may be a high power node, e.g., a macro eNB. For example, a serving macro eNB may communicate the measurement pattern and neighbor cell list to the low power nodes which are interfered with by an aggressor cell. This information may be used by UEs to perform measurements on cells served by the lower power nodes. The aggressor cell may be the serving macro eNB itself or another macro eNB.

Note that the embodiments described above also describe specific patterns, e.g., ABS from the aggressor cell and restricted patterns for neighbor victim cells. However, the embodiments herein are equally applicable to other signal transmit patterns comprising low power, low interference subframes or time-frequency resources, e.g., subframes, with reduced signal transmission activity or any combination thereof, e.g., subframes with low power and reduced activity. The embodiments herein are also equally applicable to other signal transmit patterns comprising lower power or low interference time-frequency resources, e.g., certain RBs in certain time slots or subframes.

The embodiments herein may be also applicable for each serving cell or each component carrier used by the UE when the UE operates in multi-cell scenarios. Examples of multi-cell scenarios include carrier aggregation or multi-carrier, CoMP, CoMP with carrier aggregation, etc. . . . . The method may be applied for each cell or carrier independently or jointly depending upon the multi-cell scenario. For example, in carrier aggregation each carrier typically has a different aggressor cell. Alternatively, in CoMP the single carrier usually means the serving cells have the same aggressor cell.

The above mentioned and described embodiments are only given as examples and should not be limiting. Other solutions, uses, objectives, and functions within the scope of the accompanying patent claims may be possible.

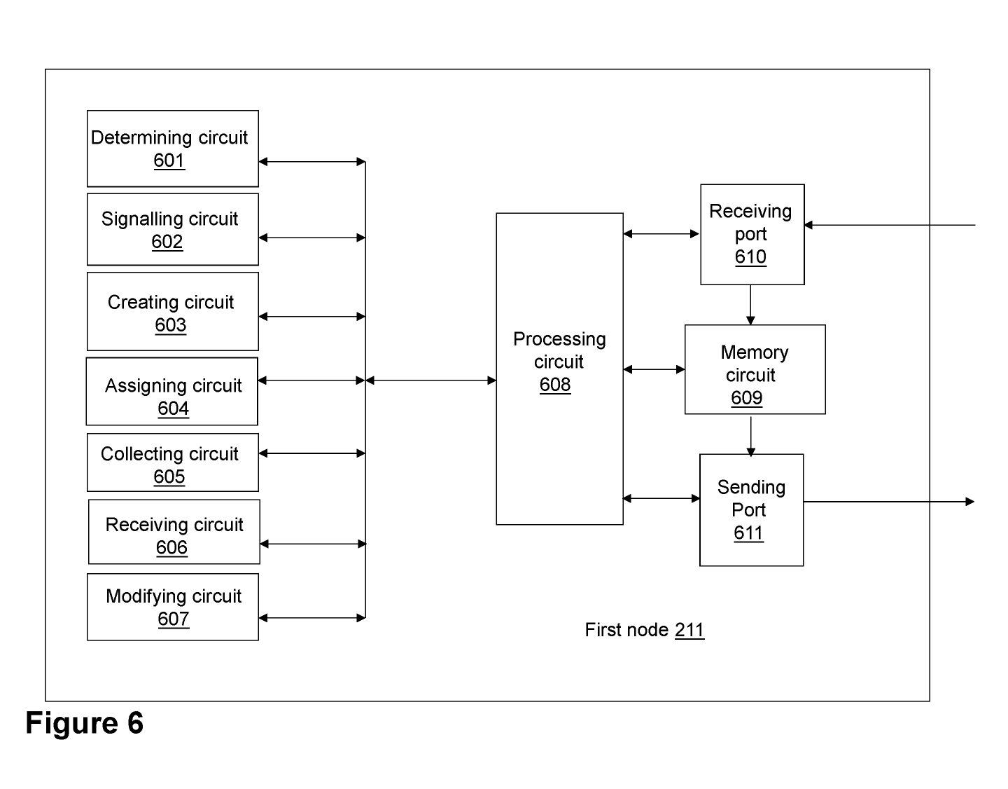

To perform the method actions in the first node 211 described above in relation to FIGS. 3, 4 and 5 for managing time-frequency resources, the first node 211 comprises the following arrangement depicted in FIG. 6. The first node 211 is configured to be comprised in the wireless network 200. The first node 211 is configured to serve the at least one user equipment 250 configured to operate in the wireless network 200. The at least one user equipment 250 configured to be served by the first node 211 receives interference from the second node 212 when in operation. In some embodiments, the first node 211 may be configured to implement inter-cell interference coordination.

The detailed description of some of the following features corresponds to the same description provided above, in relation to the actions described for the first node 211, and will thus not be repeated here.

The first node 211 comprises a determining circuit 601 is configured to determine one of: the blanking ratio of the low interference time-frequency resource pattern, and the amount of required protected time-frequency resources. The determining circuit 601 is configured to determine based on the one or more parameters related to the at least one user equipment 250 configured to be served by the first node 211. To determine is for recommending to the second node 212 comprised in the wireless network 200. As stated earlier, the second node 212 is configured to use the low interference time-frequency resource pattern.

In some embodiments, the low interference time-frequency resource pattern is one of: an Almost Blank Subframe pattern, and a signal transmit pattern comprising low interference time-frequency resources.

In some embodiments, the blanking ratio of the low interference time-frequency resource pattern comprises one or more of: a. the number of low interference time-frequency resources in the low interference time-frequency resource pattern; b. the ratio of low interference time-frequency resources to the total number of time-frequency resources during a radio frame.

In some embodiments, the one or more parameters may comprise: user equipment 250 statistics in a cell range expansion region, i.e., CRE region, of a cell 221 configured to be served by the first node 211, user equipment 250 statistics regarding the one or more patterns of protected time-frequency resources in the cell 221 configured to be served by the first node 211, user equipment 250 traffic in the cell 221 configured to be served by the first node 211, utilization of protected resources in the cell 221 configured to be served by the first node 211, and density of protected time-frequency resource patterns configured to be used in the first node 211.

The first node 211 also comprises a signalling circuit 602 configured to signal to the second node 212 information. The information comprises at least one of: the determined blanking ratio of the low interference time-frequency resource pattern, the determined required amount of protected time-frequency resources, and the one or more parameters.

In some embodiments, the information configured to be signalled to the second node 212 comprises at least one of: an indication of increase or decrease of utilization of allocated protected resources, an indication to increase or decrease an allocation of protected resources, an indication of a target amount of protected resources needed, an indication of usable protected resources allocated by all nodes generating interference affecting the first node 211, and an indication of an overall amount of protected resources allocated by all nodes generating interference affecting the first node 211.

In some embodiments, the first node 211 may also comprise a creating circuit 603 configured to create one or more measurement patterns containing protected time-frequency resources, to enable the at least one user equipment 250 configured to be served by the first node 211 to perform measurements on protected resources, wherein the protected time-frequency resources overlap resources in the low interference time-frequency resource pattern configured to be used by the second node 212.

In some embodiments wherein the first node 211 is configured to serve more than one user equipment 250, the determining circuit 601 may be further configured to determine which user equipments 250 configured to be served by the first node 211 are in the region configured to be served by the first node 211 receiving strong interference from the second node 212. In these embodiments, the creating circuit 603 may be further configured to create the one or more measurement patterns based on traffic of the determined user equipments 250 in the region, and the determining circuit 601 may be further configured to determine which user equipments 250 based on one of: a. user equipments 250 whose signal quality with respect to the serving cell 221 served by the first node 211 is below a threshold; and b. at least one relative signal measurement comparing measurements performed on signals from the serving cell 221 and the reference cell.

In some embodiments, the first node 211 may also comprise an assigning circuit 604 configured to assign the one or more measurement patterns to the at least one user equipment 250 configured to be served by the first node 211.

In some embodiments, the first node 211 may also comprise a collecting circuit 605 configured to collect statistics of the one or more measurement patterns when used over time.

In some embodiments, the first node 211 may also comprise a receiving circuit 606 configured to receive from the second node 212 an update related to the low interference time-frequency resource pattern configured to be used by the second node 212.

In some embodiments, the first node 211 may also comprise a modifying circuit 607 configured to modify one or more measurement patterns for the user equipments 250 configured to be served by the first node 211, based on the received update.

In some embodiments, the modified one or more measurement patterns are at least one of: the measurement resource restriction pattern for a primary cell 221, the measurement resource restriction pattern for one or more neighbour cells, and the resource restriction pattern for channel state information measurement of the primary cell 221.

The embodiments herein for managing time-frequency resources in the first node 211 may be implemented through one or more processors, such as a processing circuit 608 in the first node 211 depicted in FIG. 6, together with computer program code for performing the functions and actions of the embodiments herein. The program code mentioned above may also be provided as a computer program product, for instance in the form of a data carrier carrying computer program code for performing the embodiments herein when being loaded into the in the first node 211. One such carrier may be in the form of a CD ROM disc. It may be however feasible with other data carriers such as a memory stick. The computer program code may furthermore be provided as pure program code on a server and downloaded to the first node 211.

The first node 211 may further comprise a memory circuit 609 comprising one or more memory units. The memory circuit 609 may be arranged to be used to store data such as, information created, assigned, determined, collected, signalled, received and/or modified by the processing circuit 608 in relation to applications to perform the methods herein when being executed in the first node 211. Memory circuit 609 may be in communication with the processing circuit 608. Any of the other information processed by the processing circuit 608 may also be stored in the memory circuit 609.

In some embodiments, information such as the update related to the low interference time-frequency resource pattern used by the second node received from the second node 212, may be received through a receiving port 610. In some embodiments, the receiving port 610 may be, for example, connected to the one or more antennas in the first node 211. In other embodiments, the first node 211 may receive information from another structure in the wireless network 200 through the receiving port 610. Since the receiving port 610 may be in communication with the processing circuit 608, the receiving port 610 may then send the received information to the processing circuit 608. The receiving port 610 may also be configured to receive other information.

The information created, assigned, determined, collected, signalled, received and/or modified by the processing circuit 608 in relation to the method disclosed herein, may be stored in the memory circuit 609 which, as stated earlier, may be in communication with the processing circuit 608 and the receiving port 610.

The processing circuit 608 may be further configured to signal information, such as the determined blanking ratio, the determined required amount of protected time-frequency resources, and the one or more parameters to the second node 212, through a sending port 611, which may be in communication with the processing circuit 608, and the memory circuit 609.

Those skilled in the art will also appreciate that the determining circuit 601, the signalling circuit 602, the creating circuit 603, the assigning circuit 604, the collecting circuit 605, the receiving circuit 606 and the modifying circuit 607 described above may refer to a combination of analog and digital circuits, and/or one or more processors configured with software and/or firmware (e.g., stored in memory) that, when executed by the one or more processors such as the processing circuit 608, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

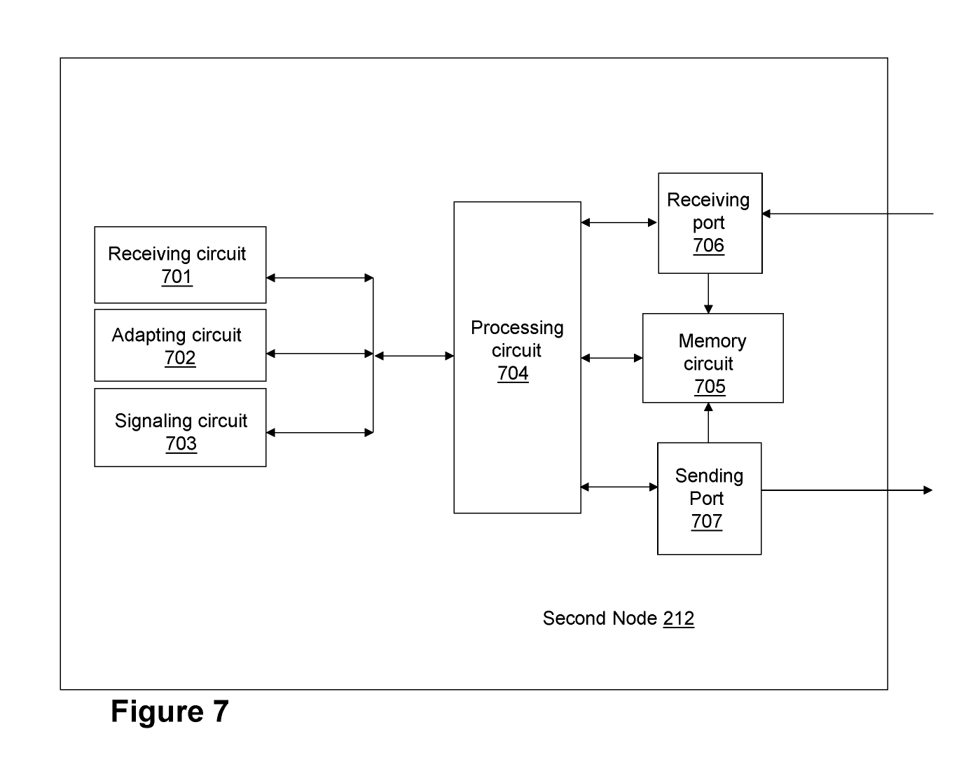

To perform the method actions in the second node 212 described above in relation to FIGS. 4 and 5 for managing time-frequency resources, the second node 212 comprises the following arrangement depicted in FIG. 7. The second node 212 is configured to be comprised in the wireless network 200. In some embodiments, the second node 212 may be configured to implement inter-cell interference coordination.

The detailed description of some of the following features corresponds to the same description provided above, in relation to the actions described for the second node 212, and will thus not be repeated here.

The second node 212 comprises a receiving circuit 701 configured to receive the information from at least a first node 211 configured to be comprised in the wireless network 200. The information comprises at least one of: the blanking ratio of the low interference time-frequency resource pattern, the required amount of protected time-frequency resources, and the one or more parameters related to the at least one user equipment 250 configured to be served by the first node 211. The low interference time-frequency resource pattern is configured to be used by the second node 212. The blanking ratio of the low interference time-frequency resource pattern is configured to be determined by the first node 211 based on the one or more parameters and configured to be recommended by the first node 211. The required amount of protected time-frequency resources is configured to be determined by the first node 211 based on the one or more parameters and configured to be recommended by the first node 211.

The at least one user equipment 250 configured to be served by the first node 211 is configured to operate in the wireless network 200 and receives interference from the second node 212 when in operation.

In some embodiments, the receiving circuit 701 may be configured to receive information related to a recommended blanking ratio and/or required protected time-frequency resources from one or more victim network nodes.

In some embodiments, the low interference time-frequency resource pattern may be one of: an Almost Blank Subframe pattern, and a signal transmit pattern comprising low interference time-frequency resources.

In some embodiments, the received information from the first node 211 may comprise at least one of: the indication of increase or decrease of utilization of allocated protected resources, the indication to increase or decrease an allocation of protected resources, the indication of a target amount of protected resources needed, the indication of usable protected resources allocated by all nodes generating interference affecting the first node 211, and the indication of an overall amount of protected resources allocated by all nodes generating interference affecting the first node 211.

The second node 212 further comprises an adapting circuit 702 configured to adapt the low interference time-frequency resource pattern configured to be used by the second node 212, based on the received information.

In some embodiments, the adapting circuit 702 may be further configured to adapt a blanking ratio of the low interference time-frequency resource pattern configured to be used by the second node 212, based on the received information.

In some particular embodiments, to adapt may comprise to modify a utilization of the low interference time-frequency resource pattern configured to be used by the second node 212, based on the received information.

In some embodiments, to adapt may comprise to change a type of the low interference time-frequency resource pattern configured to be used by the second node 212, based on the received information.

For example, the adapting circuit 702 may be configured to selectively modify the protected time-frequency resources to comport with the recommended blanking ratio and/or required protected time-frequency resources received from the victim node.

The second node 212, in some embodiments may comprise a signaling circuit 703 configured to signal the updated low interference time-frequency resource pattern information to the first node 211.

In some embodiments, the updated low interference time-frequency resource pattern information may comprise at least one of: the adapted blanking ratio of the low interference time-frequency resource pattern used by the second node (212), and the changed type of the low interference time-frequency resource pattern used by the second node (212).

In some embodiments, the signaling circuit 703 is further configured to signal any modifications made to the protected time-frequency resources to affected victim network nodes.

The embodiments herein for performing one or more network operational tasks may be implemented through one or more processors, such as a processing circuit 704 in the second node 212 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the in the second node 212. One such carrier may be in the form of a CD ROM disc. It may be however feasible with other data carriers such as a memory stick. The computer program code may furthermore be provided as pure program code on a server and downloaded to the second node 212.

The second node 212 may further comprise a memory circuit 705 comprising one or more memory units. The memory circuit 705 may be arranged to be used to store data such as, the information received by the processing circuit 704 in relation to applications to perform the methods herein when being executed in the second node 212. Memory circuit 705 may be in communication with the processing circuit 704. Any of the other information processed by the processing circuit 704 may also be stored in the memory circuit 705.

In some embodiments, information from the first nodes 211 may be received through a receiving port 706. In some embodiments, the receiving port 706 may be, for example, connected to the one or more antennas in the second node 212. In other embodiments, the second node 212 may receive information from another structure in the wireless network 200 through the receiving port 706. Since the receiving port 706 may be in communication with the processing circuit 704, the receiving port 706 may then send the received information to the processing circuit 704. The receiving port 706 may also be configured to receive other information.

The information received by the processing circuit 704 in relation to methods herein, may be stored in the memory circuit 705 which, as stated earlier, may be in communication with the processing circuit 704 and the receiving port 706.

The processing circuit 704 may be further configured to send or signal information to, for example, the first node 211 through a sending port 707, which may be in communication with the processing circuit 704, and the memory circuit 705.

Those skilled in the art will also appreciate that the receiving circuit 701, the adapting circuit 702 and the signalling circuit 703 described above may refer to a combination of analog and digital circuits, and/or one or more processors configured with software and/or firmware (e.g., stored in memory) that, when executed by the one or more processors such as the processing circuit 704, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The embodiments herein are not limited to the above described embodiments. Various alternatives, modifications and equivalents may be used. Therefore, the above embodiments should not be taken as limiting the scope, which is defined by the appending claims.

In the above-description of various embodiments, it is to be understood that the terminology used herein is for the purpose of describing particular embodiments only and is not intended to be limiting. Unless otherwise defined, all terms, including technical and scientific terms, used herein have the same meaning as commonly understood by one of ordinary skill in the art to which these embodiments belong. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it may be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus, i.e., systems and/or devices, and/or computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means, i.e., functionality, and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments may be embodied in hardware and/or in software, (including firmware, resident software, micro-code, etc. . . . that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification shall support claims to any such combination or subcombination.

### ABBREVIATIONS

3GPP 3^{rd} Generation Partnership Project
BS Base Station
CP Cyclic Prefix
CRS Cell-specific Reference Signal
DL Downlink
eNodeB evolved Node B
E-SMLC Evolved SMLC
IE Information Element
LTE Long-Term Evolution
MDT Minimization of Drive Tests
PCI Physical Cell Identity
RF Radio Frequency
RRC Radio Resource Control
RSRP Reference Signal Received Power
RSRQ Reference Signal Received Quality
RSSI Received Signal Strength Indicator
SINR Signal-to-Interference Ratio
SON Self-Optimized Network
SRS Sounding Reference Signals
UE User Equipment
UL Uplink
UMTS Universal Mobile Telecommunications System
UTDOA UL Time Difference of Arrival

TABLE 1

| | | | | |
|---|---|---|---|---|
| IE/Group Name | Presence | Range | IE type and reference | Semantics description |

| | | | |
|---|---|---|---|
| DL ABS status | M | INTEGER (0 . . . 100) | Percentage of used ABS |
| | | | resources. The numerator of |
| | | | the percentage calculation |
| | | | consists of resource blocks |
| | | | within the ABS indicated in the |
| | | | Usable ABS Pattern Info IE |
| | | | allocated by the eNB₂ for UEs |
| | | | needing protection by ABS |
| | | | from inter-cell interference for |
| | | | DL scheduling, or allocated by |
| | | | the eNB₂ for other reasons |
| | | | (e.g., some control channels). |
| | | | The denominator of the |
| | | | percentage calculation is the |
| | | | total quantity of resource |
| | | | blocks within the ABS |
| | | | indicated in the Usable ABS |
| | | | Pattern Info IE. |
| CHOICE Usable ABS | M | — | — |
| Information | | | |
| >FDD | | — | — |
| >>Usable ABS Pattern | M | BIT STRING (SIZE(40)) | Each position in the bitmap |
| Info | | | represents a subframe, for |
| | | | which value “1” indicates ‘ABS |
| | | | that has been designated as |
| | | | protected from inter-cell |
| | | | interference by the eNB₁, and |
| | | | available to serve this purpose |
| | | | for DL scheduling in the eNB₂’ |
| | | | and value “0” is used for all |
| | | | other subframes. |
| | | | The pattern represented by the |
| | | | bitmap is a subset of, or the |
| | | | same as, the corresponding |
| | | | ABS Pattern Info IE conveyed |
| | | | in the LOAD INFORMATION |
| | | | message from the eNB₁. |
| >TDD | | — | — |
| >>Usable ABS Pattern | M | BIT STRING (1 . . . 70) | Each position in the bitmap |
| Info | | | represents a subframe, for |
| | | | which value “1” indicates ‘ABS |
| | | | that has been designated as |
| | | | protected from inter-cell |
| | | | interference by the eNB₁, and |
| | | | available to serve this purpose |
| | | | for DL scheduling in the eNB₂’ |
| | | | and value “0” is used for all |
| | | | other subframes. |
| | | | The pattern represented by the |
| | | | bitmap is a subset of, or the |
| | | | same as, the corresponding |
| | | | ABS Pattern Info IE conveyed |
| | | | in the LOAD INFORMATION |
| | | | message from the eNB₁. |
| Utilisation Change Request | O | INTEGER (−20 . . . 20) | The actual value is IE value * |
| | | | 0.5 dB. |
| Protected Resources | O | Enumerated (increase, | Indicates increase or decrease |
| Change Request | | decrease, . . .) | of protected resources |
| Target Blanking Ratio | O | INTEGER (0 . . . 10) | Indicates the amount of |
| | | | protected subfames required |

TABLE 2

| | | | |
|---|---|---|---|
| CHOICE Usable ABS | M | — | — |
| Information | | | |
| >FDD | | — | — |
| >>Usable ABS Pattern | M | BIT STRING (SIZE(40)) | Each position in the bitmap |
| Info | | | represents a subframe, for |
| | | | which value “1” indicates ‘ABS |
| | | | that has been designated as |
| | | | protected from inter-cell |
| | | | interference [symbol] and |
| | | | available to serve this purpose |
| | | | for DL scheduling in the eNB₂’ |
| | | | and value “0” is used for all |
| | | | other subframes. |
| | | | The pattern represented by the |
| | | | bitmap is a subset of, or the |
| | | | same as, the corresponding |
| | | | ABS Pattern Info IE conveyed |
| | | | in the LOAD INFORMATION |
| | | | message [symbol] |
| >TDD | | — | — |
| >>Usable ABS Pattern | M | BIT STRING (1 . . . 70) | Each position in the bitmap |
| Info | | | represents a subframe, for |
| | | | which value “1” indicates ‘ABS |
| | | | that has been designated as |
| | | | protected from inter-cell |
| | | | interference [symbol] and |
| | | | available to serve this purpose |
| | | | for DL scheduling in the eNB₂’ |
| | | | and value “0” is used for all |
| | | | other subframes. |
| | | | The pattern represented by the |
| | | | bitmap is a subset of, or the |
| | | | same as, the corresponding |
| | | | ABS Pattern Info IE conveyed |
| | | | in the LOAD INFORMATION |
| | | | message [symbol] |
| CHOICE Overall ABS | O | — | — |
| Information | | | |
| >FDD | | — | — |
| >>Overall ABS Pattern | O | BIT STRING (SIZE(40)) | Each position in the bitmap |
| Info | | | represents a subframe, for |
| | | | which value “1” indicates ‘ABS |
| | | | that has been designated as |
| | | | protected from inter-cell |
| | | | interference and value “0” is |
| | | | used for all other subframes. |
| >TDD | | — | — |
| >>Overall ABS Pattern | O | BIT STRING (1 . . . 70) | Each position in the bitmap |
| Info | | | represents a subframe, for |
| | | | which value “1” indicates ‘ABS |
| | | | that has been designated as |
| | | | protected from inter-cell |
| | | | interference and value “0” is |
| | | | used for all other subframes. |

1-34. (canceled)

35. A method, in a first node, for managing time-frequency resources, the first node being in a wireless network, and the first node serving at least one user equipment operating in the wireless network and receiving interference from a second node, the method comprising:
determining, based on one or more parameters related to the at least one user equipment served by the first node, at least one of:
a blanking ratio of a low interference time-frequency resource pattern; and
an amount of required protected time-frequency resources;
signaling, to the second node, information comprising at least one of:
the determined blanking ratio of the low interference time-frequency resource pattern;
the determined required amount of protected time-frequency resources; and.
the one or more parameters related to the at least one user equipment.

36. The method of claim 35, further comprising:
creating one or more measurement patterns containing protected time-frequency resources, to enable the at least one user equipment served by the first node to perform measurements on protected resources, wherein the protected time-frequency resources overlap resources in the low interference time-frequency resource pattern used by the second node; and
assigning the one or more measurement patterns to the at least one user equipment served by the first node.

37. The method of claim 36, further comprising collecting statistics of the one or more measurement patterns used over time.

38. The method of claim 36:
wherein the first node serves more than one user equipment;
wherein the method further comprises determining which user equipments served by the first node are in a region served by the first node receiving strong interference from the second node;
wherein the creating one or more measurement patterns is based on traffic of the determined user equipments in the region;
wherein the determining is based on one of:
user equipments whose signal quality with respect to a serving cell served by the first node is below a threshold; and
at least one relative signal measurement comparing measurements performed on signals from the serving cell and a reference cell.

39. The method of claim 35, wherein the one or more parameters comprise:
user equipment statistics in a cell range expansion region of a cell served by the first node;
user equipment statistics regarding the one or more patterns of protected time-frequency resources in the cell served by the first node;
user equipment traffic in the cell served by the first node;
utilization of protected resources in the cell served by the first node; and
density of protected time-frequency resource patterns used in the first node.

40. The method of claim 35, wherein the information signaled to the second node comprises at least one of:
an indication of increase or decrease of utilization of allocated protected resources;
an indication to increase or decrease an allocation of protected resources;
an indication of a target amount of protected resources needed;
an indication of usable protected resources allocated by all nodes generating interference affecting the first node; and
an indication of an overall amount of protected resources allocated by all nodes generating interference affecting the first node.

41. The method of claim 35, further comprising:
receiving, from the second node, an update related to the low interference time-frequency resource pattern used by the second node;
modifying one or more measurement patterns for the user equipments served by the first node, based on the received update.

42. The method of claim 41, wherein the modified one or more measurement patterns are at least one of:
a measurement resource restriction pattern for a primary cell;
a measurement resource restriction pattern for one or more neighbor cells; and
a resource restriction pattern for channel state information measurement of the primary cell.

43. The method of claim 35, wherein the blanking ratio of the low interference time-frequency resource pattern comprises one or more of:
a number of low interference time-frequency resources in the low interference time-frequency resource pattern;
a ratio of low interference time-frequency resources to a total number of time-frequency resources during a radio frame.

44. The method of claim 35, wherein the low interference time-frequency resource pattern is one of:
an Almost Blank Subframe pattern;
a signal transmit pattern comprising low interference time-frequency resources.

45. A method, in a second node, for managing time-frequency resources, the second node being in a wireless network, the method comprising:
receiving information from a first node comprised in the wireless network, the information comprising at least one of:
a blanking ratio of a low interference time-frequency resource pattern, wherein the low interference time-frequency resource pattern is used by the second node;
a required amount of protected time-frequency resources; and
one or more parameters related to at least one user equipment served by the first node;
adapting the low interference time-frequency resource pattern used by the second node, based on the received information;
wherein the at least one user equipment served by the first node operates in the wireless network and receives interference from the second node.

46. The method of claim 45, wherein the received information from the first node comprises at least one of:
an indication of increase or decrease of utilization of allocated protected resources;
an indication to increase or decrease an allocation of protected resources;
an indication of a target amount of protected resources needed;
an indication of usable protected resources allocated by all nodes generating interference affecting the first node; and
an indication of an overall amount of protected resources allocated by all nodes generating interference affecting the first node.

47. The method of claim 45, wherein the adapting comprises adapting a blanking ratio of the low interference time-frequency resource pattern used by the second node, based on the received information.

48. The method of claim 47, further comprising signaling updated low interference time-frequency resource pattern information to the first node.

49. The method of claim 45, wherein the adapting comprises modifying a utilization of the low interference time-frequency resource pattern used by the second node, based on the received information.

50. The method of claim 45, wherein the adapting comprises changing a type of the low interference time-frequency resource pattern used by the second node, based on the received information.

51. The method of claim 45, wherein the low interference time-frequency resource pattern is one of:
an Almost Blank Subframe pattern; and
a signal transmit pattern comprising low interference time-frequency resources.

52. A first node for managing time-frequency resources, the first node being configured to be in a wireless network, and the first node being configured to serve at least one user equipment configured to operate in the wireless network, the first node comprising:
a determining circuit configured to determine, based on one or more parameters related to the at least one user equipment configured to be served by the first node, one of:
a blanking ratio of a low interference time-frequency resource pattern; and
an amount of required protected time-frequency resources;
wherein the determination of the determining circuit is for recommending to a second node comprised in the wireless network, the second node being configured to use the low interference time-frequency resource pattern;
a signaling circuit configured to signal information to the second node, the information comprising at least one of:
the determined blanking ratio of the low interference time-frequency resource pattern;
the determined required amount of protected time-frequency resources;
the one or more parameters;
wherein the at least one user equipment configured to be served by the first node receives interference from the second node when in operation.

53. The first node of claim 52, further comprising:
a creating circuit configured to create one or more measurement patterns containing protected time-frequency resources, to enable the at least one user equipment configured to be served by the first node to perform measurements on protected resources, wherein the protected time-frequency resources overlap resources in the low interference time-frequency resource pattern configured to be used by the second node; and
an assigning circuit configured to assign the one or more measurement patterns to the at least one user equipment configured to be served by the first node.

54. The first node of claim 53, further comprising a collecting circuit configured to collect statistics of the one or more measurement patterns when used over time.

55. The first node of claim 53:
wherein the first node is configured to serve more than one user equipment;
wherein the determining circuit is further configured to determine which user equipments configured to be served by the first node are in a region configured to be served by the first node receiving strong interference from the second node;
wherein the creating circuit is further configured to create the one or more measurement patterns based on traffic of the determined user equipments in the region;
wherein the determining circuit is further configured to determine which user equipments based on one of:
user equipments whose signal quality with respect to a serving cell served by the first node is below a threshold; and
at least one relative signal measurement comparing measurements performed on signals from the serving cell and a reference cell.

56. The first node of claim 52, wherein the one or more parameters comprise:
user equipment statistics in a cell range expansion region of a cell configured to be served by the first node;
user equipment statistics regarding the one or more patterns of protected time-frequency resources in the cell configured to be served by the first node;
user equipment traffic in the cell configured to be served by the first node;
utilization of protected resources in the cell configured to be served by the first node;
density of protected time-frequency resource patterns configured to be used in the first node.

57. The first node of claim 52, wherein the information configured to be signaled to the second node comprises at least one of:
an indication of increase or decrease of utilization of allocated protected resources;
an indication to increase or decrease an allocation of protected resources;
an indication of a target amount of protected resources needed;
an indication of usable protected resources allocated by all nodes generating interference affecting the first node, and
an indication of an overall amount of protected resources allocated by all nodes generating interference affecting the first node.

58. The first node of claim 52, further comprising:
a receiving circuit configured to receive, from the second node, an update related to the low interference time-frequency resource pattern configured to be used by the second node; and
a modifying circuit configured to modify one or more measurement patterns for the user equipments configured to be served by the first node, based on the received update.

59. The first node of claim 58, wherein the modified one or more measurement patterns are at least one of:
a measurement resource restriction pattern for a primary cell;
a measurement resource restriction pattern for one or more neighbor cells, and
a resource restriction pattern for channel state information measurement of the primary cell.

60. The first node of claim 52, wherein the blanking ratio of the low interference time-frequency resource pattern comprises one or more of:
a number of low interference time-frequency resources in the low interference time-frequency resource pattern;
a ratio of low interference time-frequency resources to a total number of time-frequency resources during a radio frame.

61. The first node of claim 52, wherein the low interference time-frequency resource pattern is one of:
an Almost Blank Subframe pattern; and
a signal transmit pattern comprising low interference time-frequency resources.

62. A second node for managing time-frequency resources, the second node being configured to be comprised in a wireless network, the second node comprising:
a receiving circuit configured to receive information from a first node in the wireless network, the information comprising at least one of:
a blanking ratio of a low interference time-frequency resource pattern, wherein the low interference time-frequency resource pattern is configured to be used by the second node;
a required amount of protected time-frequency resources; and
one or more parameters related to at least one user equipment configured to be served by the first node,
wherein the blanking ratio of the low interference time-frequency resource pattern was determined by the first node based on the one or more parameters and configured to be recommended by the first node;
wherein the required amount of protected time-frequency resources was determined by the first node based on the one or more parameters and configured to be recommended by the first node;
an adapting circuit configured to adapt the low interference time-frequency resource pattern configured to be used by the second node, based on the received information; and
wherein the at least one user equipment configured to be served by the first node is configured to operate in the wireless network and receives interference from the second node when in operation.

63. The second node of claim 62, wherein the information received from the first node comprises at least one of:
an indication of increase or decrease of utilization of allocated protected resources;
an indication to increase or decrease an allocation of protected resources;
an indication of a target amount of protected resources needed;
an indication of usable protected resources allocated by all nodes generating interference affecting the first node; and
an indication of an overall amount of protected resources allocated by all nodes generating interference affecting the first node.

64. The second node of claim 62, wherein the adapting circuit is configured to adapt a blanking ratio of the low interference time-frequency resource pattern configured to be used by the second node, based on the received information.

65. The second node of claim 64, further comprising a signaling circuit configured to signal updated low interference time-frequency resource pattern information to the first node.

66. The second node of claim 62, wherein the adapting circuit is configured to modify a utilization of the low interference time-frequency resource pattern configured to be used by the second node, based on the received information.

67. The second node of claim 62, wherein the adapting circuit is configured to change a type of the low interference time-frequency resource pattern configured to be used by the second node, based on the received information.

68. The second node of claim 62, wherein the low interference time-frequency resource pattern is one of:
an Almost Blank Subframe pattern; and
a signal transmit pattern comprising low interference time-frequency resources.
